(19) United States
(12) Patent Application Publication
(10) Pub. No.: US 2025/0301318 A1
(43) Pub. Date: Sep. 25, 2025

(54) Reuse of Security Context for Access and Registration

(71) Applicant: Telefonaktiebolaget LM Ericsson (publ), Stockholm (SE)

(72) Inventors: Vesa Lehtovirta, Espoo (FI); Cheng Wang, Shanghai (CN); David Castellanos Zamora, Madrid (ES)

(21) Appl. No.: 18/863,458

(22) PCT Filed: Jun. 9, 2023
(86) PCT No.: PCT/EP2023/065521

§ 371 Date: Nov. 6, 2024

(30) Foreign Application Priority Data
Jun. 20, 2022 (WO) PCT/CN2022/099894

(51) Int. Cl. H04W 12/06; H04W 12/0431; H04W 60/04; H04W 84/12

(52) U.S. Cl. CPC H04W 12/06; H04W 12/0431; H04W 60/04; H04W 84/12

(57) ABSTRACT

Embodiments include methods for a user equipment (UE) configured to communicate with a communications network via a first access network. Such methods include, without registering with the communications network, receiving from the communications network an authentication-related message. Such methods include generating the following based on the authentication-related message: a first security key usable for establishing a secure connection with the first access network, and second security key(s) usable for communicating with the communications network. Such methods include establishing a secure connection with the first access network based on the first security key and registering with the communication network based on at least one of the second security keys. Other embodiments include complementary methods for first, second, and third network nodes or functions (NNFs) of the communications network, as well as UEs and NNFs configured to perform such methods.

### TECHNICAL FIELD

The present disclosure relates generally to communication networks and more specifically to techniques for user equipment (UEs) to access wireless LANs (or other access networks) based on user credentials for a public land mobile network (PLMN, e.g., 5G network), and for subsequent registration of the UE with the PLMN based on the same user credentials.

### BACKGROUND

The fifth generation (5G) of cellular systems was initially standardized 3GPP Release 15 (Rel-15) and continues to evolve in subsequent releases. NR is developed for maximum flexibility to support a variety of different use cases including enhanced mobile broadband (eMBB), machine type communications (MTC), ultra-reliable low latency communications (URLLC), side-link device-to-device (D2D), and several other use cases. 5G/NR technology shares many similarities with fourth-generation LTE.

At a high level, the 5G System (5GS) consists of an Access Network (AN) and a Core Network (CN). The AN provides UEs connectivity to the CN, e.g., via base stations such as gNBs or ng-eNBs. As described in more detail below, the CN includes a variety of Network Functions (NF) that provide a range of different functionalities such as session management, connection management, charging, authentication, etc.

FIG. 1 illustrates a high-level view of an exemplary 5G network architecture, which includes a Next Generation Radio Access Network (NG-RAN, 199) and a 5G Core (5GC, 198). The NG-RAN can include one or more gNodeB's (gNBs, e.g., 100, 150) connected to the 5GC via one or more NG interfaces (e.g., 102, 152). More specifically, the gNBs can be connected to one or more Access and Mobility Management Functions (AMFs) in the 5GC via respective NG-C interfaces and to one or more User Plane Functions (UPFs) in the 5GC via respective NG-U interfaces. Various other network functions (NFs) can be included in the 5GC, as described below.

In addition, the gNBs can be connected to each other via one or more Xn interfaces (e.g., 140 between gNBs 100, 150). The radio technology for the NG-RAN is often referred to as “New Radio” (NR). With respect to the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells.

NG RAN logical nodes shown in FIG. 1 include a Centralized Unit (CU or gNB-CU) and one or more Distributed Units (DU or gNB-DU). CUs (e.g., 110) are logical nodes that host higher-layer protocols and perform various gNB functions such controlling the operation of DUs. In contrast, DUs (e.g., 120, 130) are decentralized logical nodes that host lower layer protocols and can include, depending on the functional split option, various subsets of gNB functions. A CU connects to one or more DUs over respective F1 logical interfaces (e.g., 122, 132).

A change in 5G networks (e.g., in 5GC) is that traditional peer-to-peer interfaces and protocols found in earlier-generation networks are modified and/or replaced by a Service Based Architecture (SBA) in which Network Functions (NFs) provide one or more services to one or more service consumers. This can be done, for example, by Hyper Text Transfer Protocol/Representational State Transfer (HTTP/REST) application programming interfaces (APIs). In general, the various services are self-contained functionalities that can be changed and modified in an isolated manner without affecting other services.

The 5G SBA model is based on principles including modularity, reusability, and self-containment of NFs, which can enable network deployments to take advantage of the latest virtualization and software technologies. In the 5G SBA, network repository functions (NRF) allow every network function to discover the services offered by other network functions, and Data Storage Functions (DSF) allow every network function to store its context.

3GPP has defined architectures to support UE accessing 5GC via trusted or untrusted non-3GPP access networks (e.g., WLAN). The architecture for trusted non-3GPP access to 5GC includes an interworking function (TWIF) that enables Non-5G-Capable over WLAN (N5CW) devices to access 5GC via trusted WLAN access networks. Additionally, 3GPP has defined an architecture that enables a UE to connect to a WLAN access network using its 5GS credentials without registration to 5GS. This architecture is based on the Non-Seamless WLAN Offload Function (NSWOF), which interfaces to the WLAN access network using the SWa interface as defined in 3GPP TS 23.402 (v17.0.0). NSWOF also interfaces to an authentication server function (AUSF) in 5GC via the Nausf Service Based Interface (SBI).

### SUMMARY

In the current 3GPP specifications, if the UE decides to access a WLAN by performing NSWO access and then decides to register to 5GC, authentication needs to be run twice, first for NSWO access and then for registering with 5GC via trusted/untrusted non-3GPP access. These two registrations may occur near in time, which requires excessive signaling and processing in both UE and 5GC.

An object of embodiments of the present disclosure is to improve registration of UEs via non-3GPP access, such as by facilitating solutions to overcome exemplary problems summarized above and described in more detail below.

Some embodiments include methods (e.g., procedures) for a UE configured to communicate with a communications network (e.g., 5GC) via at least a first access network.

These exemplary methods include, without registering with the communications network, receiving from the communications network an authentication-related message. These exemplary methods also include generating the following based on the authentication-related message: a first security key usable for establishing a secure connection with the first access network, and one or more second security keys usable for communicating with the communications network. These exemplary methods also include establishing a secure connection with the first access network based on the first security key and registering with the communications network based on at least one of the second security keys.

In some embodiments, the first security key is a master session key (MSK) or a non-seamless WLAN offload (NSWO) key, the communications network is a 5G network, and the one or more second security keys include K_{AUSF}, K_{SEAF}, and K_{AMF}.

In some of these embodiments, the first access network is one of the following: a trusted wireless local area network (WLAN), a trusted non-3GPP access network, or a non-trusted non-3GPP access network. In some of these embodiments, registering with the communications network is based on K_{AMF}.

In some embodiments, registering with the communications network is via the secure connection with the first access network. In other embodiments, registering with the communications network is via a second access network different than the first access network.

Other embodiments include methods (e.g., procedures) for a first network node or function (NNF, e.g., NSWOF) of a communications network (e.g., 5GC).

These exemplary methods include receiving, from a UE via a first access network, a first authentication message that includes an identifier associated with user credentials for the communication network. These exemplary methods include sending, to a second NNF of the communications network, an authentication request that includes the identifier and an indication that the UE should be authenticated for accessing the first access network and for registration with the communications network. These exemplary methods include receiving the following from the second NNF: an authentication response indicating that the UE is authenticated according to the indication, and a first security key usable for establishing a secure connection between the UE and the first access network. These exemplary methods include forwarding the first security key to the first access network and the authentication response to the UE via the first access network.

In some embodiments, the first access network is one of the following: a trusted WLAN, a trusted non-3GPP access network, or a non-trusted non-3GPP access network. In some embodiments, the first security key is one of the following: a master session key (MSK), or a non-seamless wireless LAN offload (NSWO) key.

In some embodiments, the communications network is a 5G network, the first NNF is an NSWOF, and the second NNF is one of the following: an AMF separate from the NSWOF, an AMF combined with the NSWOF, or an AUSF.

Other embodiments include methods (e.g., procedures) for a second NNF (e.g., AMF) of a communications network (e.g., 5GC).

These exemplary methods include receiving, from a first NNF of the communications network, an authentication request for a UE. The authentication request includes the following: an identifier associated with user credentials for the communication network, and an indication that the UE should be authenticated for accessing a first access network and for registration with the communications network. These exemplary methods include sending the following information to the first NNF: an authentication response indicating that the UE is authenticated in accordance with the indication, and a first security key usable for establishing a secure connection between the UE and the first access network.

In some embodiments, these exemplary methods can also include the following operations:
sending, to a third NNF of the communications network, a further authentication request for the UE, wherein the further authentication request includes the indication and the identifier associated with the user credentials; and
receiving the following from the third NNF: the authentication response, a second identifier associated with user credentials for the communication network, and a security key (K_{SEAF}) associated with a security anchor function (SEAF) of the communications network; and
deriving a security key associated with the second NNF based on the security key (K_{SEAF}) associated with the SEAF.

In some embodiments, the communications network is a 5G network, the first NNF is an NSWOF, the second NNF is an AMF, and the third NNF is an AUSF. In some of these embodiments, the first access network is one of the following: a trusted WLAN, a trusted non-3GPP access network, or a non-trusted non-3GPP access network.

In some embodiments, the second NNF is combined with the first NNF. In other embodiments, or the second NNF is separate from the first NNF.

Other embodiments include methods (e.g., procedures) for a third NNF of a communications network (e.g., 5GC).

These exemplary methods include receiving, from a first NNF of the communications network, an authentication request for a UE. The authentication request includes the following: an identifier associated with user credentials for the communication network, and an indication that the UE should be authenticated for accessing the WLAN and for registration with the communications network. These exemplary methods include sending to the first NNF an authentication response indicating that the UE is authenticated in accordance with the indication. These exemplary methods include sending the following information to a second NNF of the communications network: a second identifier associated with user credentials for the communication network, and a security key (K_{SEAF}) associated with a security anchor function (SEAF) of the communications network.

In some embodiments, these exemplary methods can also include the following operations:
in response to the authentication request, sending a further authentication request for the UE to a fourth NNF of the communications network, wherein the further authentication request includes the identifier associated with the user credentials;
receiving the following from the fourth NNF: the second identifier, and an authentication vector usable to generate security keys for communication with the UE; and
deriving the following based on the authentication vector: a first security key usable for establishing a secure connection between the UE and the first access network, the security key (K_{SEAF}) associated with the SEAF, and a security key associated with the third NNF.

In some of these embodiments, the communications network is a 5G network, the second NNF is an AMF, the third NNF is an AUSF, and the fourth NNF is a UDM function. In different variants, the first NNF can be an AMF or an NSWOF. In some variants, the first access network is one of the following: a trusted wireless local area network (WLAN), a trusted non-3GPP access network, or a non-trusted non-3GPP access network.

Other embodiments include UEs (e.g., wireless devices) and NNFs (e.g., NSWOFs, AMFs, and AUSFs) configured to perform operations corresponding to any of the exemplary methods described herein. Other embodiments include non-transitory, computer-readable media storing program instructions that, when executed by processing circuitry, configure such UEs and NNFs to perform operations corresponding to any of the exemplary methods described herein.

These and other embodiments described herein can provide various benefits and/or advantages. For example, since only one authentication procedure is needed for a UE, embodiments can reduce the signaling between UE and involved network entities, as well as processing load in UE and involved network entities, relative to conventional techniques that require two authentication procedures. Additionally, embodiments facilitate smaller delay when a UE registers to 5GC since the UE's NAS security context is already available from earlier access-related authentication. Also, embodiments maintain AMF as a main authentication anchor point in all cases including authentication for NSWO, non-3GPP access, and 3GPP access, which is very desirable.

These and other objects, features, and advantages of embodiments of the present disclosure will become apparent upon reading the following Detailed Description in view of the Drawings briefly described below.

### BRIEF DESCRIPTION OF THE DRAWINGS

FIGS. 1-2 illustrate various aspects of an exemplary 5G network architecture.

FIGS. 3-4 show exemplary non-roaming architectures for 5GC with untrusted and trusted non-3GPP access by UEs, respectively.

FIG. 5 shows an exemplary non-roaming architecture for N5CW device access via trusted WLAN.

FIG. 6 shows a 3GPP-defined architecture that enables a UE to connect to a WLAN using its 5GS credentials without registration to 5GS.

FIG. 7 shows a signaling diagram of an authentication procedure for untrusted, non-3GPP accesses to 5GC.

FIG. 8 (which includes FIGS. 8A-C) shows a signaling diagram of a procedure for authentication and PDU session establishment via trusted, non-3GPP accesses to 5GC.

FIG. 9 (which includes FIGS. 9A-B) shows a signaling diagram of an authentication procedure for N5CW devices that access 5GC via trust WLAN.

FIG. 10 shows a signaling diagram of an authentication procedure for Non-seamless WLAN offload (NSWO) in 5GC.

FIGS. 11-12 show exemplary non-roaming architectures for 5GC with untrusted and trusted non-3GPP access by UEs, respectively, according to some embodiments of the present disclosure.

FIG. 13 shows an exemplary non-roaming architecture for N5CW device access via trusted WLAN, according to other embodiments of the present disclosure.

FIGS. 14-21 show signaling diagrams for various authentication procedures for NSWO in 5GS, according to various embodiments of the present disclosure.

FIG. 22 shows an exemplary method (e.g., procedure) for a UE, according to various embodiments of the present disclosure.

FIG. 23 shows an exemplary method (e.g., procedure) for an NSWOF, according to various embodiments of the present disclosure.

FIG. 24 shows an exemplary method (e.g., procedure) for an AMF, according to various embodiments of the present disclosure.

FIG. 25 shows an exemplary method (e.g., procedure) for an AUSF, according to various embodiments of the present disclosure.

FIG. 26 shows a communication system according to various embodiments of the present disclosure.

FIG. 27 shows a UE according to various embodiments of the present disclosure.

FIG. 28 shows a network node according to various embodiments of the present disclosure.

FIG. 29 shows host computing system according to various embodiments of the present disclosure.

FIG. 30 is a block diagram of a virtualization environment in which functions implemented by some embodiments of the present disclosure may be virtualized.

FIG. 31 illustrates communication between a host computing system, a network node, and a UE via multiple connections, at least one of which is wireless, according to various embodiments of the present disclosure.

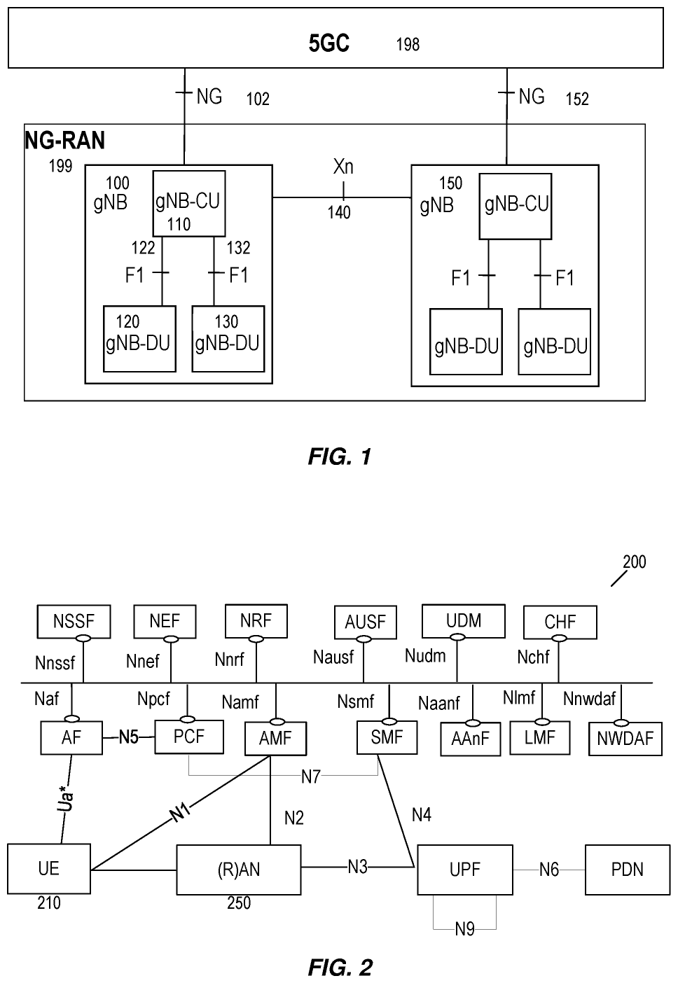

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

In general, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The operations of any methods and/or procedures disclosed herein do not have to be performed in the exact order disclosed, unless an operation is explicitly described as following or preceding another operation and/or where it is implicit that an operation must follow or precede another operation. Any feature of any embodiment disclosed herein can apply to any other disclosed embodiment, as appropriate.

Likewise, any advantage of any embodiment described herein can apply to any other disclosed embodiment, as appropriate.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node) based on its specific characteristics in any given context.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is generally used. However, the concepts disclosed herein are not limited to a 3GPP system, and can be applied in any system that can benefit from the concepts, principles, and/or embodiments described herein.

FIG. 2 shows an exemplary non-roaming reference architecture for a 5G network (200) including the following 3GPP-defined NFs and service-based interfaces:
Application Function (AF, with Naf interface) interacts with the 5GC to provision information to the network operator and to subscribe to certain events happening in operator's network. An AF offers applications for which service is delivered in a different layer (i.e., transport layer) than the one in which the service has been requested (i.e., signaling layer), the control of flow resources according to what has been negotiated with the network. An AF communicates dynamic session information to PCF (via N5 interface), including description of media to be delivered by transport layer.
Policy Control Function (PCF, with Npcf interface) supports unified policy framework to govern the network behavior, via providing PCC rules (e.g., on the treatment of each service data flow that is under PCC control) to the SMF via the N7 reference point. PCF provides policy control decisions and flow based charging control, including service data flow detection, gating, QoS, and flow-based charging (except credit management) towards the SMF. The PCF receives session and media related information from the AF and informs the AF of traffic (or user) plane events.
User Plane Function (UPF)—supports handling of user plane traffic based on the rules received from SMF, including packet inspection and different enforcement actions (e.g., event detection and reporting). UPFs communicate with the RAN (e.g., NG-RNA) via the N3 reference point, with SMFs (discussed below) via the N4 reference point, and with an external packet data network (PDN) via the N6 reference point. The N9 reference point is for communication between two UPFs.
Session Management Function (SMF, with Nsmf interface) interacts with the decoupled traffic (or user) plane, including creating, updating, and removing Protocol Data Unit (PDU) sessions and managing session context with the User Plane Function (UPF), e.g., for event reporting. For example, SMF performs data flow detection (based on filter definitions included in PCC rules), online and offline charging interactions, and policy enforcement.
Charging Function (CHF, with Nchf interface) is responsible for converged online charging and offline charging functionalities. It provides quota management (for online charging), re-authorization triggers, rating conditions, etc. and is notified about usage reports from the SMF. Quota management involves granting a specific number of units (e.g., bytes, seconds) for a service. CHF also interacts with billing systems.

Access and Mobility Management Function (AMF, with Namf interface) terminates the RAN CP interface and handles all mobility and connection management of UEs (similar to MME in EPC). AMFs communicate with UEs via the N1 reference point and with the RAN (e.g., NG-RAN) via the N2 reference point.
Network Exposure Function (NEF) with Nnef interface—acts as the entry point into operator's network, by securely exposing to AFs the network capabilities and events provided by 3GPP NFs and by providing ways for the AF to securely provide information to 3GPP network. For example, NEF provides a service that allows an AF to provision specific subscription data (e.g., expected UE behavior) for various UEs. In general, NEF provides services similar to services provided by SCEF in EPC.
Network Repository Function (NRF) with Nnrf interface—provides service registration and discovery, enabling NFs to identify appropriate services available from other NFs.
Network Slice Selection Function (NSSF) with Nnssf interface—a “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice. The NSSF enables other NFs (e.g., AMF) to identify a network slice instance that is appropriate for a UE's desired service.
Authentication Server Function (AUSF) with Nausf interface—based in a user's home network (HPLMN), it performs user authentication and computes security key materials for various purposes.
Network Data Analytics Function (NWDAF) with Nnwdaf interface—provides network analytics information (e.g., statistical information of past events and/or predictive information) to other NFs on a network slice instance level.
Location Management Function (LMF) with Nlmf interface—supports various functions related to determination of UE locations, including location determination for a UE and obtaining any of the following: DL location measurements or a location estimate from the UE; UL location measurements from the NG RAN; and non-UE associated assistance data from the NG RAN.

The Unified Data Management (UDM) function supports generation of 3GPP authentication credentials, user identification handling, access authorization based on subscription data, and other subscriber-related functions. To provide this functionality, the UDM uses subscription data (including authentication data) stored in the 5GC unified data repository (UDR). In addition to the UDM, the UDR supports storage and retrieval of policy data by the PCF, as well as storage and retrieval of application data by NEF. The terms “UDM” and “UDM function” are used interchangeably herein.

The NRF allows every NF to discover the services offered by other NFs, and Data Storage Functions (DSF) allow every NF to store its context. In addition, the NEF provides exposure of capabilities and events of the 5GC to AFs within and outside of the 5GC. For example, NEF provides a service that allows an AF to provision specific subscription data (e.g., expected UE behavior) for various UEs.

The services provided by the various NFs are composed of “service operations”, which are more granular divisions of the overall service functionality. The interactions between service consumers and producers can be of the type “request/response” or “subscribe/notify”. In the latter type, a service consumer NF (or equivalently, “consumer NF”) requests a service producer NF (or equivalently, “producer NF”) to establish a subscription for the service consumer NF to receive notifications from the service producer NF under conditions specified in this subscription.

Service Communication Proxy (SCP) is a 5GC NF that was introduced in Rel-16. SCP provides centralized capabilities such as service-based interface (SBI) routing, NF discovery and selection, failover, message screening, etc. More generally, SCP facilitates 5GC implementation in a highly distributed multi-access edge compute cloud environment. SCP provides a single point of entry for a cluster of NFs after they have been successfully discovered by the NRF. As such, the SCP becomes the delegated discovery point in a data center, offloading NRF from the distributed service meshes that can comprise a network operator's infrastructure.

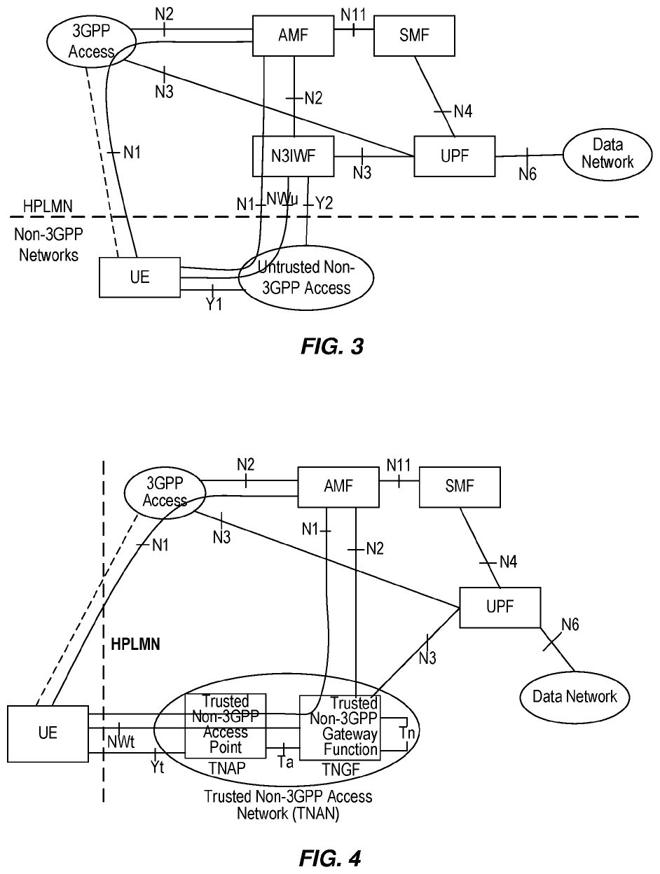

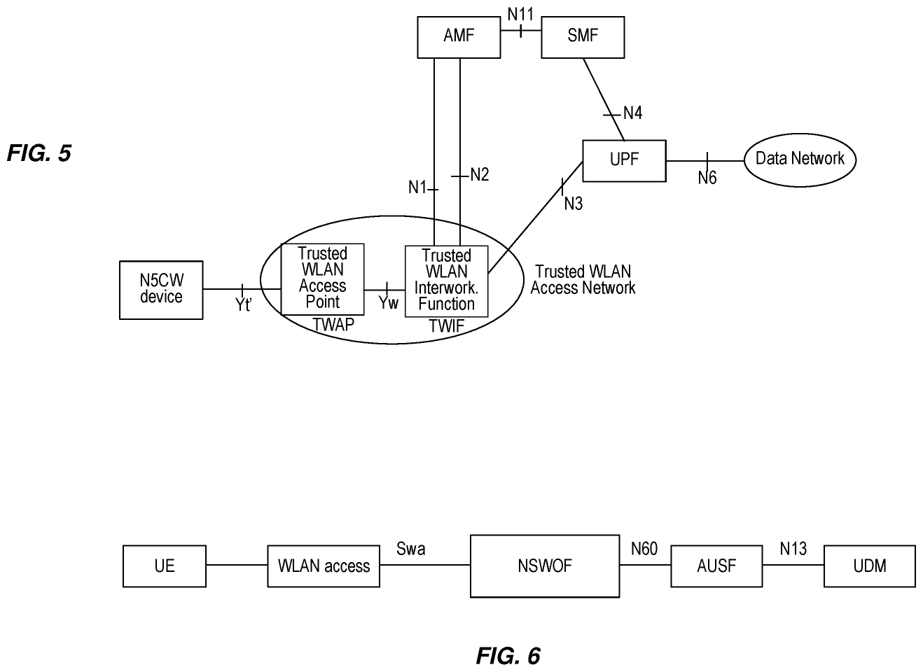

As briefly mentioned above, 3GPP has defined architectures to support UE accessing 5GC via trusted or untrusted non-3GPP access networks (e.g., WLAN). FIGS. 3 and 4 show exemplary non-roaming architectures for 5GC with untrusted and trusted non-3GPP access by UEs, respectively. 3GPP has also defined an interworking function (called TWIF) that enables Non-5G-Capable over WLAN (N5CW) devices to access 5GC via trusted WLAN access networks. FIG. 5 shows an exemplary non-roaming architecture for N5CW device access via trusted WLAN, which includes the TWIF mentioned above. Further details of the exemplary architectures shown in FIGS. 3-5 are given in 3GPP TS 23.501 (v17.4.0).

Additionally, FIG. 6 shows a 3GPP-defined architecture that enables a UE to connect to a WLAN using its 5GS credentials without registration to 5GS, which is further defined in 3GPP document S2-2203254. This architecture is based on the Non-Seamless WLAN Offload Function (NSWOF), which interfaces to the WLAN using the Sea interface as defined in 3GPP TS 23.402 (v17.0.0) and to an authentication server function (AUSF) in 5GC via the Nausf Service Based Interface (SBI). The functionality of NSWOF and the procedures applied for supporting WLAN connection using 5GS credentials for Non-seamless WLAN offload (NSWO) are further defined in 3GPP TS 33.501 (v17.5.0) Annex S. Note that 5G NWSO is not applicable to standalone non-public networks (SNPN).

The UE can also connect to a WLAN access network using 5GS credentials by performing the 5GS registration via trusted non-3GPP access procedure defined in 3GPP TS 23.502 (v17.5.0) section 4.12a.2.2. With this procedure, the UE connects to a WLAN access network using 5GS credentials and simultaneously registers in 5GS. However, the architecture shown in FIG. 6 enables a UE to connect to a WLAN access network using 5GS credentials but without registration in 5GS.

If the WLAN is configured as Untrusted Non-3GPP access but supports IEEE 802.1x, 5G NSWO may be used to access the WLAN. Any time after the UE obtains the connection to WLAN network and the local IP address, the UE may initiate Untrusted Non-3GPP Access to obtain the access to 5GC.

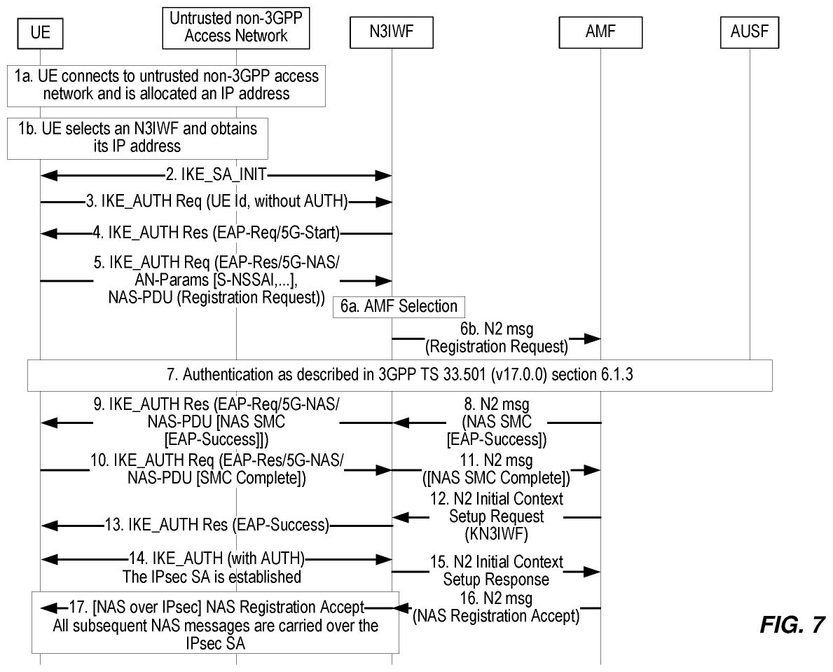

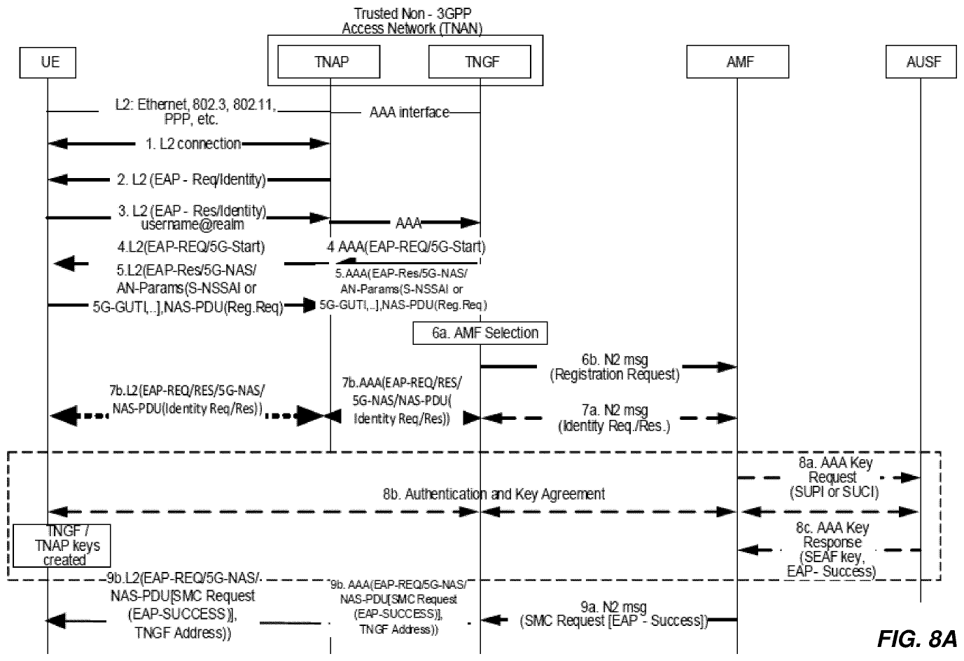

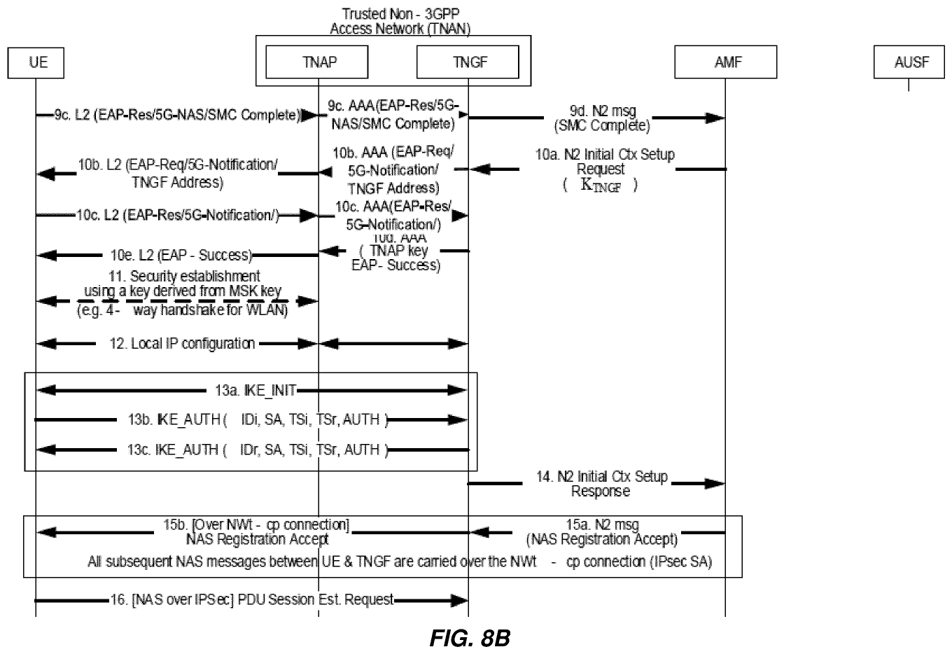

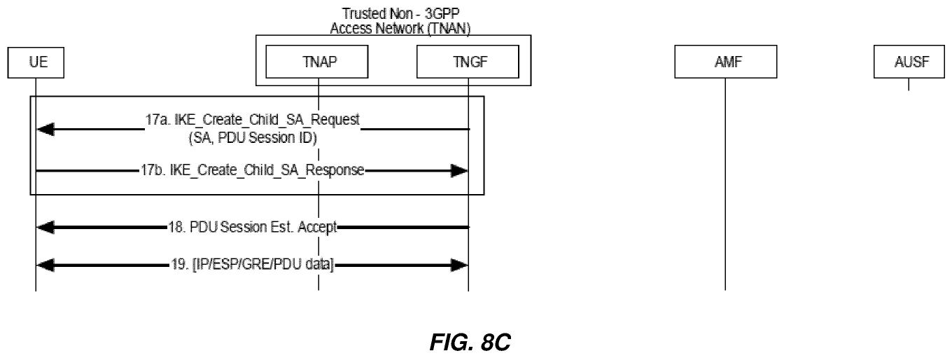

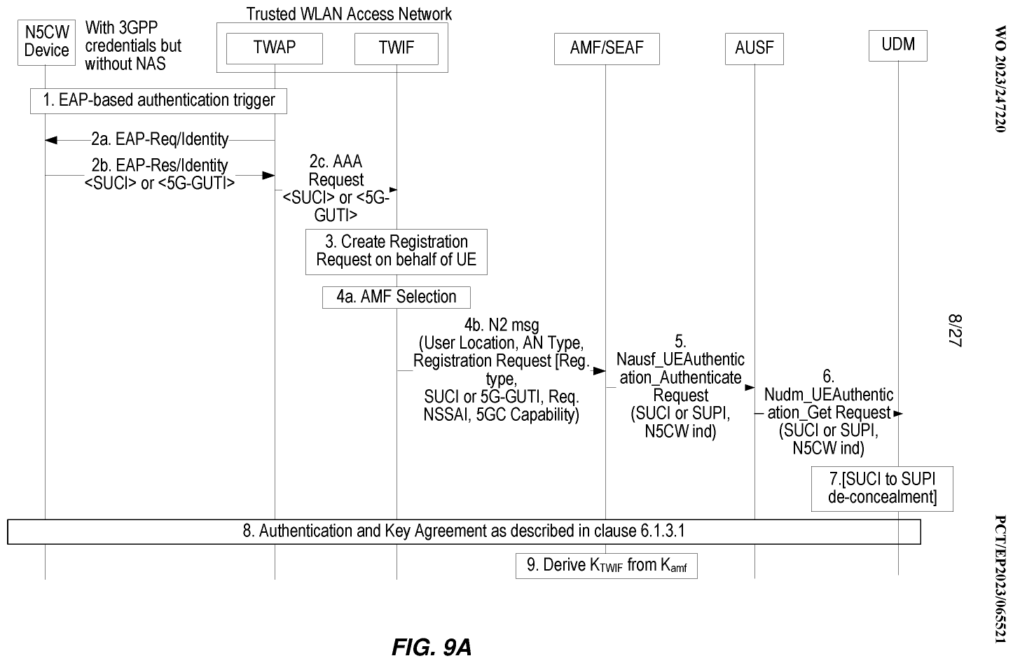

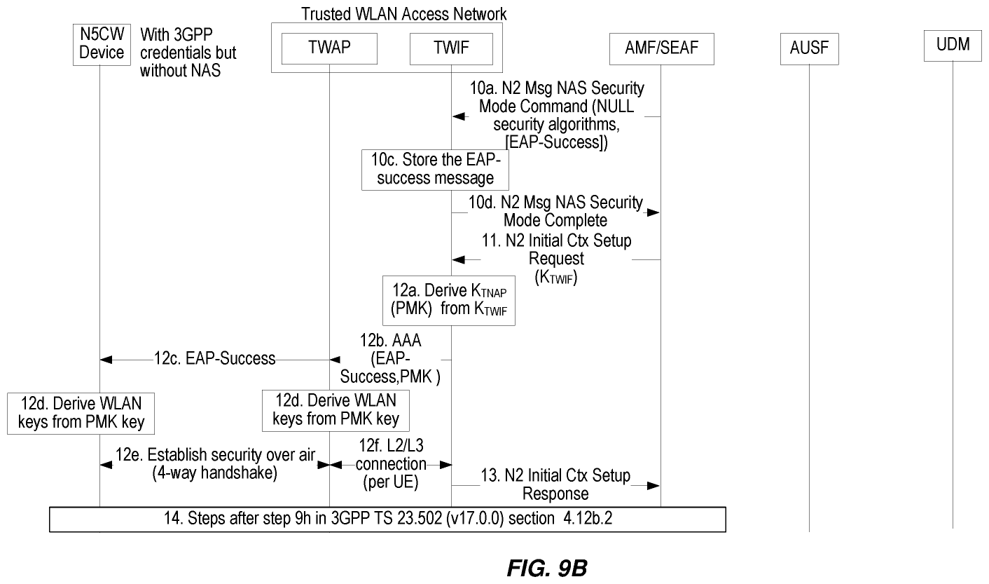

FIG. 7 shows a signaling diagram of an authentication procedure for untrusted, non-3GPP accesses to 5GC. FIG. 8 (which includes FIGS. 8A-C) shows a signaling diagram of a procedure for authentication and PDU session establishment via trusted, non-3GPP accesses to 5GC. Likewise, FIG. 9 (which includes FIGS. 9A-B) shows a signaling diagram of an authentication procedure for N5CW devices that access 5GC via trust WLAN. These procedures are further specified in 3GPP TS 33.501 (v17.5.0) sections 7.2.1, 7A.2.1, and 7A.2.4, respectively.

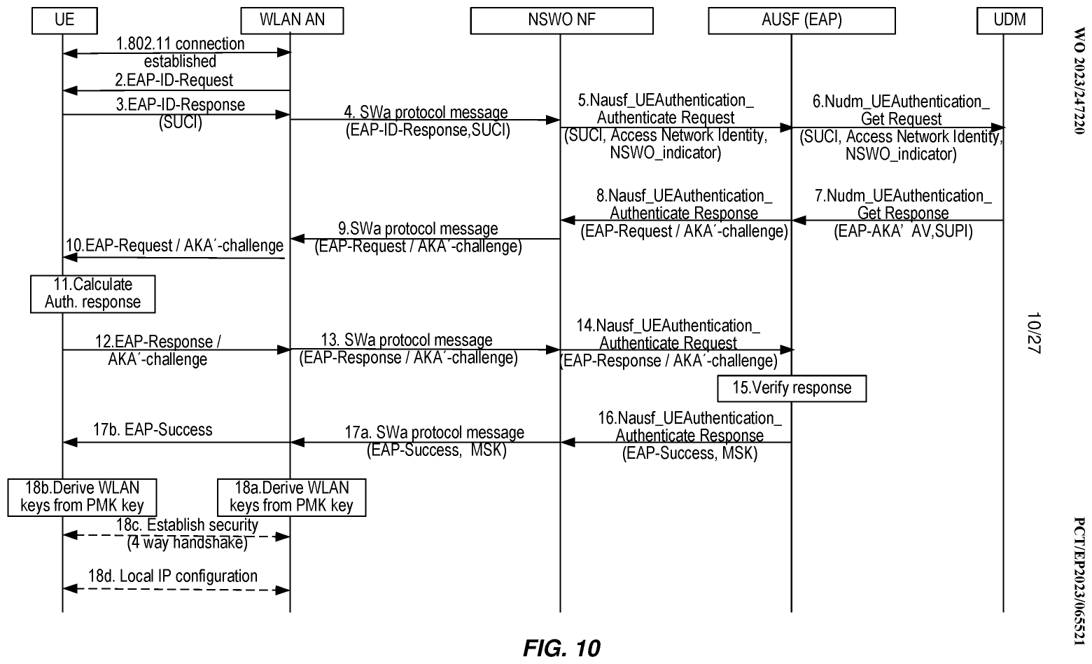

FIG. 10 shows a signaling diagram of an authentication procedure for Non-seamless WLAN offload (NSWO) in 5GC. This procedure is further specified in 3GPP TS 33.501 (v17.5.0) section S.3 (Annex S).

In the current 3GPP specifications, if the UE decides to access a WLAN by performing NSWO access and then decides to register to 5GC, authentication needs to be run twice, first for NSWO access and then for registering with 5GC via trusted/untrusted non-3GPP access. These two registrations may occur near in time, which requires excessive signaling and processing in both UE and 5GC.

Embodiments of the present disclosure address these and other problems, issues, and/or difficulties by novel, flexible, and efficient techniques whereby a UE can start registration to 5GC via 3GPP access or non-3GPP access using an existing NAS security context and does not have to run a new authentication. There are three main aspects of these techniques:
Key management: running authentication and key agreement involving both NSWOF and AMF so that NSWOF obtains a master session key (MSK) and AMF obtains anchor security key Kseaf.
Key identification: sending 5G global unique temporary identifier (GUTI) and NAS key set identifier (ngKSI) from AMF to AUSF, which then sends those protected to the UE.
Security algorithm negotiation: sending chosen NAS security algorithms from AMF to AUSF which sends those protected to the UE.

According to these techniques, when authentication and key agreement is performed for NSWO access, AMF also prepares keys and other parameters for NAS security. This allows the UE to later register to the 5GC without having to perform authentication again. For this to be possible, three security problems need to be solved: 1) Key management, 2) key identification, 3) security algorithm negotiation. These problems and solutions are related but not strictly dependent on each other.

Certain embodiments related to key management can be summarized as follows. When authentication is performed for NSWO access authentication signaling is routed from NSWOF (more generally first network entity) via AMF (second network entity) to AUSF (third network entity or authentication server). After a successful authentication the AUSF sends Kseaf (second key) to AMF/SEAF and MSK (first key) to NSWOF possibly via AMF. This enables the NSWOF to send the MSK to WLAN AP for NSWO access, and also enables the AMF to have the Kseaf/Kamf ready when the UE later sends to AMF a request to register in 5GC via trusted/untrusted non-3GPP access or via 3GPP access.

Certain embodiments related to key identification can be summarized as follows. For the UE to indicate the correct AMF and Kseaf/Kamf keys when sending a registration request, the UE and the AMF need to have the 5G-GUTI and ngKSI available. The AMF allocates 5G-GUTI (or other temporary UE identifier) and/or ngKSI (or other key identifier) and sends them to the AUSF during the authentication procedure, and the AUSF sends those to the UE encrypted and integrity protected in EAP-AKA′ signaling (e.g., in AT_ENCR_DATA attribute or another protected attribute or parameter).

Certain embodiments related to security algorithm negotiation can be summarized as follows. UE and AMF need to agree on security algorithms for NAS protocol. One possibility is to agree using NAS SMC procedure as today. However, this may occur too late since when the UE sends a registration request with 5G-GUTI and ngKSI, that message is expected to be integrity protected using agreed-upon integrity algorithm. Therefore, the UE indicates its security algorithm capabilities during NSWO authentication and the AMF indicates the chosen security algorithm(s) via the AUSF to the UE (e.g., in AT_ENCR DATA attribute or another protected attribute or parameter).

Embodiments can provide various benefits and/or advantages. For example, since only one authentication procedure is needed for a UE, this can reduce the signaling between UE and involved network entities, as well as processing load in UE and involved network entities, relative to conventional techniques that require two authentication procedures. Additionally, embodiments facilitate smaller delay when a UE registers to 5GC since the UE's NAS security context is already available from earlier access-related authentication. Additionally, embodiments maintain AMF as the main authentication anchor point in all cases including authentication for NSWO, non-3GPP access, and 3GPP access, which is very desirable.

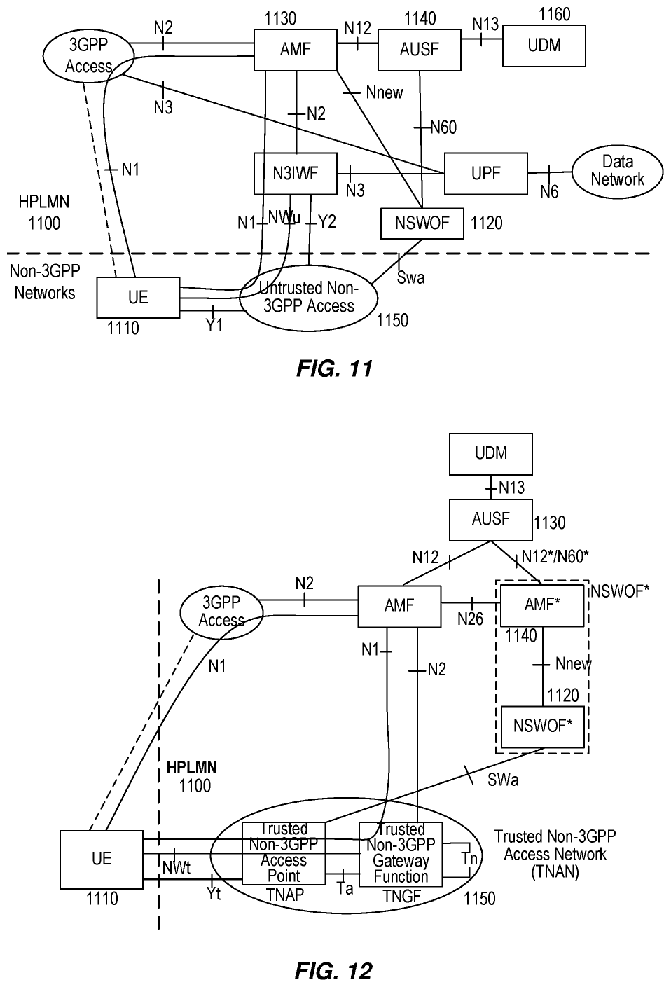

FIG. 11 shows an exemplary non-roaming architecture for 5GC with untrusted non-3GPP access by UEs, according to some embodiments of the present disclosure. The architecture shown in FIG. 11 is similar to the architecture shown in FIG. 3, except for the addition of AUSF (1140), UDM (1160), and NSWOF (1120) and their respective interfaces, including a new interface (“Nnew”) between AMF (1130) and NSWOF (1120). The UE (1110) accesses HPLMN (1100) via untrusted non-3GPP access network (1150, e.g., WLAN).

Likewise, FIG. 12 shows an exemplary non-roaming architecture for 5GC with trusted non-3GPP access by UEs, according to other embodiments of the present disclosure. The architecture shown in FIG. 12 is similar to the architecture shown in FIG. 4, except for the addition of AUSF (1140), UDM (1160), and NSWOF (1120) and their respective interfaces, including a new interface (“Nnew”) between AMF (1130) and NSWOF (1120). The UE (1110) accesses HPLMN (1100) via trusted non-3GPP access network (1150, e.g., WLAN).

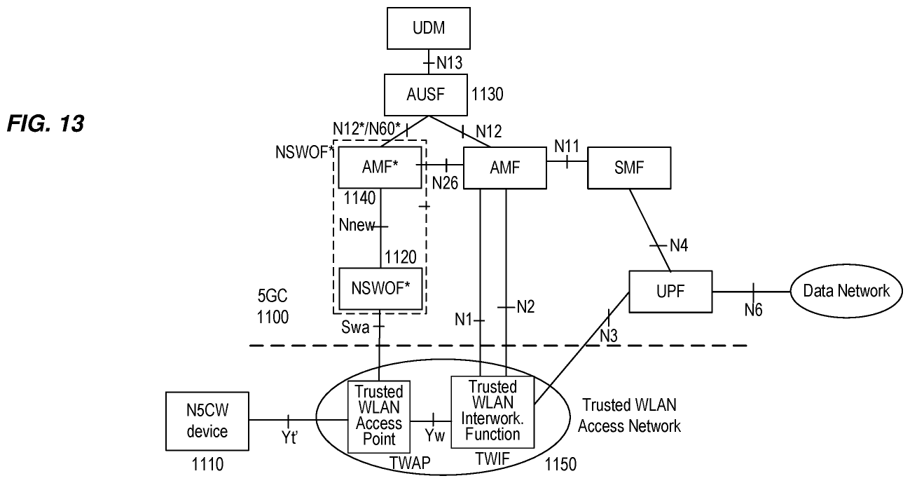

Similarly, FIG. 13 shows an exemplary non-roaming architecture for N5CW device access via trusted WLAN, according to other embodiments of the present disclosure. The architecture shown in FIG. 13 is similar to the architecture shown in FIG. 5, except for the addition of AUSF (1140), UDM (1160), and NSWOF (1120) and their respective interfaces, including a new interface (“Nnew”) between AMF (1130) and NSWOF (1120). The UE (1110) accesses 5GC (1100) via trusted WLAN (1150).

Embodiments related to key management during enhanced NSWO authentication and key agreement will now be described in more detail. These embodiments can be roughly divided into a first group in which authentication is run via NSWOF, AMF, and AUSF; and a second group in which authentication is run via NSWOF and AUSF (i.e., not involving AMF). Embodiments of these groups will be described in the context of the authentication procedure for NSWO in 5GS specified in 3GPP TS 33.501 (v17.5.0) Annex S.

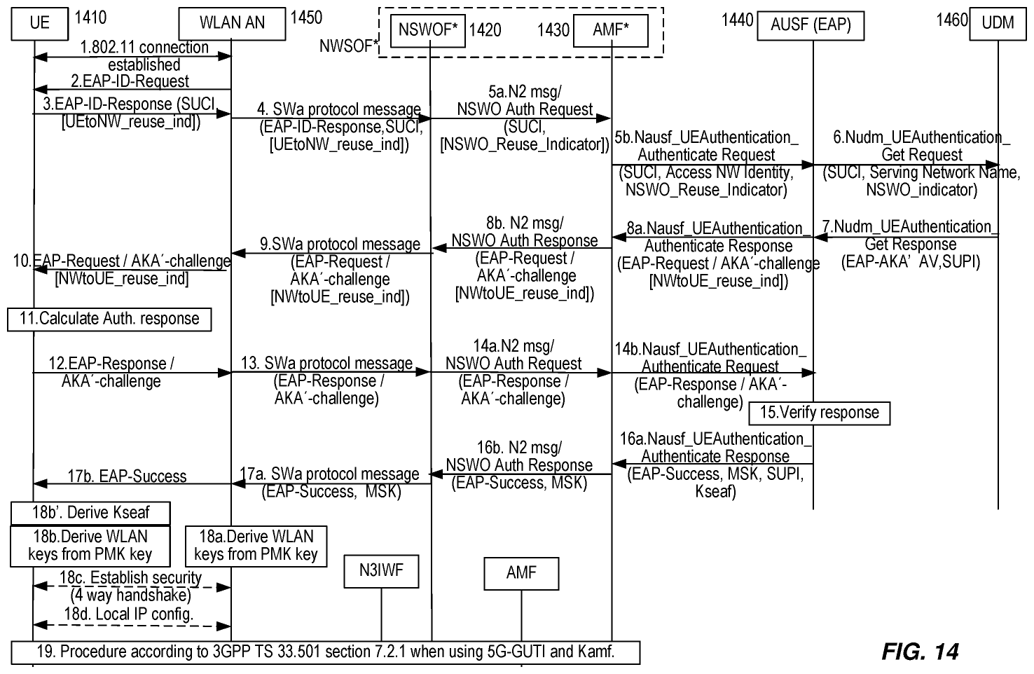

FIGS. 14-21 show signaling diagrams for various authentication procedures according to various embodiments of the present disclosure. The procedures shown in these figures involve a UE (1410), a WLAN access network (AN, 1450), an NSWOF (1420), an AMF (1430), an AUSF (1440), and a UDM (1460). These figures are described in more detail below.

FIG. 14 shows a signaling diagram for an authentication procedure for NSWO in 5GS, according to some embodiments of the present disclosure. Although the operations shown in FIG. 14 are given numerical labels, this is intended to facilitate explanation rather than to require or imply any sequential order, unless express stated or unambiguously implied by a particular context.

In operation 1, the UE establishes a connection with the WLAN AN, using procedures specified in IEEE 802.11. In operation 2, the WLAN AN sends an EAP Identity/Request to the UE. In operation 3, the UE responds with an EAP Response/Identity message. The UE uses the subscription concealed identifier (SUCI) in NAI format (i.e., username@realm format as specified in 3GPP TS 23.003 section 28.7.3]) as its identity irrespective of whether SUPI Type configured on the UE's USIM is IMSI or NAI. If the SUPI Type configured on the USIM is IMSI, the UE constructs the SUCI in NAI format with username containing the encrypted MSIN and the realm part containing the MCC/MNC. In operation 4, the EAP Response/Identity message is routed over SWa interface towards NSWOF based on the realm part of the SUCI. NSWOF acts as SBI/AAA proxy between the AUSF and the WLAN Access Network.

Both UE and network need to know when the enhanced authentication is to be run. In some embodiments, the enhanced authentication is performed by default. In other embodiments, the UE decides when the enhanced authentication is to be run. In such embodiments, the UE sends an indication (UEtoNW_reuse_indicator) to NSWOF via WLAN in operations 3-4. This indicates to the NSWOF that combined NSWO authentication and primary authentication is to be run.

In operation 5a, NSWOF determines, based on local policy (i.e., default) or an indication received from the UE in operation 4, that enhanced authentication is to be performed. NSWOF selects an AMF and sends an N2 message to the selected AMF including NSWO Auth Request message, containing SUCI, Access Network Identity and NSWO_reuse_indicator. In some variants, a specific NSWO N2 message is proposed. In other variants, an existing N2 messages can be reused and/or repurposed. In the message of operation 5a, NSWO reuse indicator can be used to indicate to AMF that the authentication request is for both NSWO and primary authentication. Alternately, the authentication request from NSWOF to AMF implicitly indicates that the authentication is for both NWSO and primary authentication (e.g., if this is a new message or service type).

In operation 5b, AMF sends the message Nausf_UEAuthentication_Authenticate Request with SUCI, Access Network Identity, and NSWO_reuse_indicator towards AUSF. In the message of operation 5b, NSWO reuse indicator can be used to indicate to AMF that the authentication request is for both NSWO and primary authentication. Alternately, the authentication request from AMF to AUSF implicitly indicates that the authentication is for both NWSO and primary authentication (e.g., if this is a new message or service type). AMF sets the Serving Network Name to “5G:NSWO:PLMNID”. The AMF can use either Access Network Identity or Serving Network name parameter.

In operation 6, AUSF checks whether AMF is entitled to use the SNN value “5G:NSWO:PLMNID”. AUSF (acting as the EAP authentication server) sends a Nudm UEAuthentication_Get Request to the UDM, including SUCI, the Serving Network Name, and an NSWO_indicator (e.g., indicating that authentication is for NSWO). After receiving the Nudm_UEAuthentication_Get Request, the UDM invokes SIDF to de-conceal SUCI to obtain the corresponding subscription permanent identifier (SUPI), which it sends to UDM. Based on the NSWO indicator, UDM selects the EAP-AKA′ authentication method and generates an authentication vector using the Access Network Identity as the KDF input parameter. In the Nudm_UEAuthentication_Get Response message of operation 7, UDM includes the EAP-AKA′ authentication vector (RAND, AUTN, XRES, CK′ and IK′) and may include SUPI.

In operation 8a, AUSF stores XRES for future verification and sends the EAP-Request/AKA′-Challenge message to the AMF in a Nausf_UEAuthentication Authenticate Response message. The Access Network Identity is carried in the AT KDF INPUT attribute in EAP-AKA′ as defined in IETF RFC 5448. In operation 8b, AMF sends the EAP-Request/AKA′-Challenge message to the NSWOF. In operation 9, NSWOF sends the EAP-Request/AKA′-Challenge message to the WLAN AN via the SWa interface. In operation 10, the WLAN AN forwards the EAP-Request/AKA′-Challenge message to the UE.

In operation 11, upon receipt of the RAND and AUTN in the EAP-Request/AKA′-Challenge message, the UE's mobile equipment (ME) obtains the Access Network Identity from the EAP signaling and the UE's USIM verifies the freshness of the AV′ by checking whether AUTN can be accepted. If so, the USIM computes a response RES and return it with CK, IK to the ME. The ME then derive CK′ and IK′ using the Access Network Identity as the key derivation function (KDF) input parameter. If the verification of the AUTN fails on the USIM, then the USIM and ME shall proceed as described in 3GPP TS 33.501 section 6.1.3.3. The UE may derive MSK from CK′ and IK′ as per 3GPP TS 33.501 Annex F and as described in IETF RFC 5448. The UE also generates key KAUSF.

In operation 12, the UE sends the EAP-Response/AKA′-Challenge message to the WLAN AN, which forwards it over the SWa interface to NSWOF in operation 13. In operation 14a, NSWOF sends the AMF an NSWO Auth Request message with EAP-Response/AKA′-Challenge using N2 message for transport. In operation 14b, the AMF sends an Nausf UEAuthentication_Authenticate Request with EAP-Response/AKA′-Challenge message to AUSF.

In operation 15, AUSF verifies that the received response RES matches the stored and expected response XRES. If successfully verified, AUSF continues to operation 16; otherwise it returns an error to AMF. The AUSF derives the required MSK and K_{AUSF} from CK′ and IK′ as per 3GPP TS 33.501 Annex F and as described in IETF RFC 5448, based on the NSWO reuse indicator received in operation 5. AUSF also generates the keys K_{AUSF} and K_{SEAF.}

In operation 16a, AUSF sends AMF an Nausf_UEAuthentication_Authenticate Response message with EAP-Success, SUPI, K_{SEAF} and MSK. AUSF/UDM shall perform the linking increased home control to subsequent procedures for registering the AUSF that holds the latest Kausf in UDM.

In operation 16b, the security anchor function (SEAF) of AMF generates Kamf from Kseaf. AMF sends an NSWO Auth Response message with EAP-Success and MSK to NSWOF via N2 message, and keeps the received SUPI and Kamf. In operation 17, NSWOF sends EAP-success and MSK to the WLAN AN over the SWa interface. The EAP-Success message is forwarded from WLAN AN to the UE. In operation 18, upon receiving the EAP-Success message, the UE derives the MSK as specified in operation 11, if it did not derived the MSK earlier. The UE also derives K_{SEAF} and Kamf, and uses MSK to perform 4-way handshake to establish a secure connection with the WLAN AN.

In operation 19, after the above-described procedure is complete, the UE can start a procedure for accessing 5GC via untrusted or trusted non-3GPP access or even via 3GPP access without having to run a new authentication. This is possible since both the UE and AMF have keys available to be able to authenticate and start NAS security.

Other embodiments based on modifications of the signaling shown in FIG. 14 are possible. For example, in some embodiments, AUSF sends only Kseaf to AMF, which derives a key (NSWO-key) from Kamf and sends that key to NSWOF. AMF derives NSWO-key based on a similar KDF as Ktngf, Kn3iwf, etc., specified in 3GPP TS 33.501 section A.9. NSWOF the provides the derived NSWO-key as a “MSK” to WLAN AN. The UE performs the same key derivations as NSWOF.

As another example, in some embodiments, instead of sending both MSK and Kseaf to AMF, AUSF sends the MSK directly to NSWOF. This requires AUSF to know the NSWOF address, which it can receive from AMF.

In some variants, NSWOF also takes on the AMF's role, performing tasks shown as being performed by AMF in FIG. 14. This option is shown in FIG. 14 by the dashed box around NSWOF and AMF.

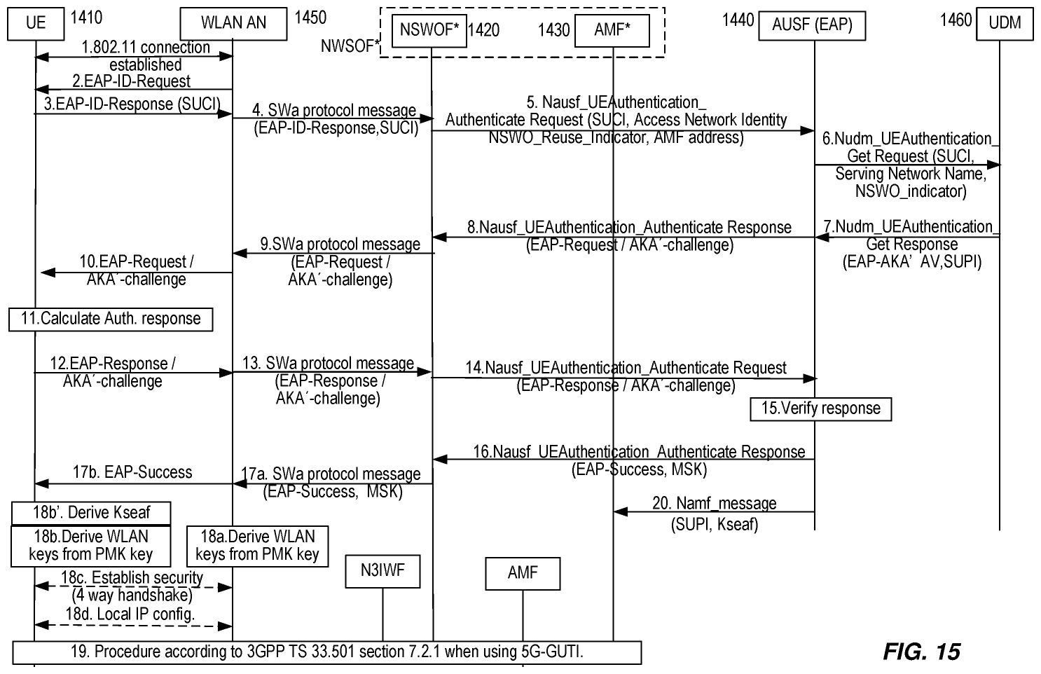

FIG. 15 shows a signaling diagram for an authentication procedure for NSWO in 5GS, according to other embodiments of the present disclosure. Although the operations shown in FIG. 15 are given numerical labels, this is intended to facilitate explanation rather than to require or imply any sequential order, unless express stated or unambiguously implied by a particular context.

Authentication is run via NSWOF and AUSF as today in NSWO authentication with the following modifications. The UEtoNW and NWtoUE reuse_indicator aspects described above also apply in these embodiments. NSWOF determines that enhanced authentication is to be run. NSWOF sends an NSWO_Reuse_Indicator and possibly the AMF address to AUSF. After a successful authentication run, AUSF sends Kseaf and SUPI to AMF. The UE also derives Kseaf.

Operation 1-4 are substantially similar to FIG. 14 operations 1-4, except that operations 3-4 do not have the option of including a UEtoNW_reuse_indicator. In operation 5, NSWOF sends an Nausf_UEAuthentication_Authenticate Request message to AUSF, including the SUCI, an Access Network Identity, an NSWO_Reuse_Indicator, and an address associated with AMF. Operations 6-7 are the same as corresponding operations in FIG. 14. In operation 8, AUSF responds to NSWOF with an Nausf_UEAuthentication_Authenticate Response message that include the EAP-Request/AKA′-Challenge.

Operations 9-13 are substantially similar to FIG. 14 operations 9-13, except that operations 9-10 do not have the option of including a NWtoUE_reuse_indicator. In operation 14, NSWOF sends an Nausf UEAuthentication Authenticate Request message to AUSF, including the UE's EAP-Response/AKA′-challenge. In operations 15-16, AUSF verifies this response and replies with an Nausf_UEAuthentication_Authenticate Response message with EAP-Success and MSK. Operations 17-19 are substantially similar to FIG. 14 operations 17-19. In operation 20, which may occur prior to or during operations 17-19, AUSF sends AMF a message that includes the UE's SUPI and Kseaf derived by the SEAF of AUSF. Alternatively, AUSF may include SUPI and Kseaf in the Nausf_UEAuthentication_Authenticate Response message to NSWOF, which may forward them to AMF.

In some variants, NSWOF also takes on AMF's role, performing tasks shown as being performed by AMF in FIG. 15. This option is shown in FIG. 15 by the dashed box around NSWOF and AMF.

Some embodiments involving key identification during enhanced NSWO authentication and key agreement procedures will now be described in the context of the authentication procedure for NSWO in 5GS specified in 3GPP TS 33.501 (v17.5.0) Annex S.

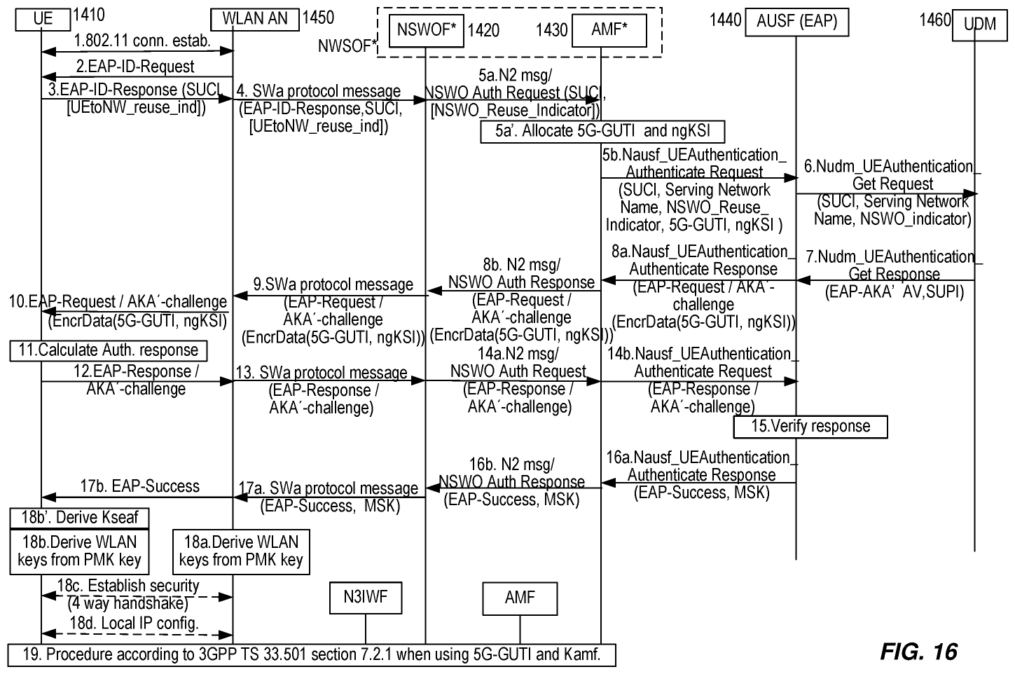

FIG. 16 shows a signaling diagram for an authentication procedure for NSWO in 5GS, according to some embodiments of the present disclosure. Although the operations shown in FIG. 16 are given numerical labels, this is intended to facilitate explanation rather than to require or imply any sequential order, unless express stated or unambiguously implied by a particular context.

Operations 1-5a are substantially similar to corresponding operations of FIG. 14. Both UE and network need to know when the enhanced authentication is to be run. In some embodiments, the enhanced authentication is performed by default. In other embodiments, the UE decides when the enhanced authentication is to be run. In such embodiments, the UE sends an indication (UEtoNW_reuse_indicator) to NSWOF via WLAN in operations 3-4. This indicates to NSWOF that combined NSWO authentication and primary authentication is to be run.

In operation 5a′, AMF allocates a 5G-GUTI and ngKSI to the UE based on the information received in operation 5a. In operation 5b, AMF sends the message Nausf_UEAuthentication_Authenticate Request with SUCI, Access Network Identity, and NSWO_reuse_indicator towards AUSF. AMF also includes the 5G-GUTI and ngKSI allocated in operation 5a′. In the message of operation 5b, NSWO_reuse_indicator can be used to indicate to AMF that the authentication request is for both NSWO and primary authentication. Alternately, the authentication request from AMF to AUSF implicitly indicates that the authentication is for both NWSO and primary authentication (e.g., if this is a new message or service type). Operations 6-7 are substantially similar to corresponding operations in FIG. 14.

In operation 8a, AUSF stores XRES for future verification and sends the EAP-Request/AKA′-Challenge message to AMF in a Nausf UEAuthentication_Authenticate Response message, which includes 5G-GUTI and ngKSI received from AMF protected in an AT_ENCR_DATA parameter. In operation 8b, AMF sends the EAP-Request/AKA′-Challenge message and the protected parameters to the NSWOF. In operation 9, NSWOF sends the EAP-Request/AKA′-Challenge message to the WLAN AN via the SWa interface. In operation 10, the WLAN AN forwards the EAP-Request/AKA′-Challenge message and the protected parameters to the UE.

In some embodiments, the network decides when the enhanced authentication is to be run. In some of these embodiments, AUSF includes an indication NWtoUE reuse indicator of enhanced authentication together with 5G-GUTI and ngKSI in the protected AT ENCR DATA field of the EAP-AKA′ sent in operation 8a, which can be forwarded to the UE in operations 8b-10. In other of these embodiments, AMF or NSWOF can provide this indication in the messages sent to the UE in operations 8b or 9, respectively.

Operations 11-19 are substantially similar to FIG. 14 operations 11-19.

In some variants, NSWOF also takes on AMF's role, performing tasks shown as being performed by AMF in FIG. 16. This option is shown in FIG. 16 by the dashed box around NSWOF and AMF.

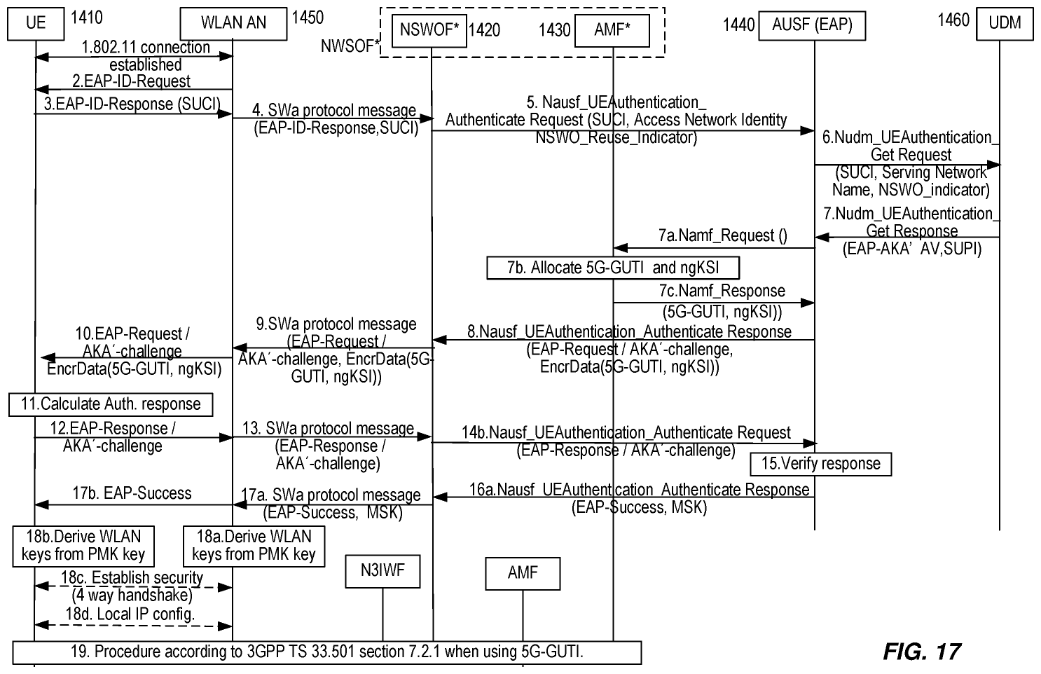

FIG. 17 shows a signaling diagram for an authentication procedure for NSWO in 5GS, according to other embodiments of the present disclosure. Although the operations shown in FIG. 17 are given numerical labels, this is intended to facilitate explanation rather than to require or imply any sequential order, unless express stated or unambiguously implied by a particular context.

Operations 1-4 are the same as FIG. 15 operations 1-4. In the embodiments shown in FIG. 17, NSWOF determines whether enhanced authentication should be performed and indicates this by including NSWO_reuse_indicator in the Nausf UEAuthentication Authenticate Request message sent to AUSF in operation 5. The NSWOF can optionally include an address associated with AMF, such as shown in FIG. 15. Operations 6-7 are the same as FIG. 15 operations 6-7.

In operations 7a-b, AMF allocates 5G-GUTI and ngKSI upon request from AUSF and provides this information to AUSF in operation 7c. In operation 8, AUSF responds to NSWOF with an Nausf UEAuthentication_Authenticate Response message that include the EAP-Request/AKA′-Challenge. AUSF also includes 5G-GUTI and ngKSI received from AMF, protected in an AT_ENCR_DATA parameter. In operation 9, NSWOF sends the EAP-Request/AKA′-Challenge message and the protected parameters to the WLAN AN via the SWa interface. In operation 10, the WLAN AN forwards the EAP-Request/AKA′-Challenge message and the protected parameters to the UE.

Operations 11-19 are substantially similar to FIG. 15 operations 11-19, except optionally the UE does not derive Kseaf as done in FIG. 15 operation 18b′.

In some variants, NSWOF also takes on AMF's role, performing tasks shown as being performed by AMF in FIG. 17. This option is shown in FIG. 17 by the dashed box around NSWOF and AMF.

In some of these embodiments, AUSF can includes an indication NWtoUE reuse indicator of enhanced authentication together with 5G-GUTI and ngKSI in the protected AT_ENCR_DATA field of the EAP-AKA′ sent in operation 8, which can be forwarded to the UE in operations 9-10. In other of these embodiments, NSWOF can provide this indication in the message sent to the UE in operation 9.

Other embodiments based on modifications of the signaling shown in FIG. 17 are possible. For example, in some embodiments, NSWOF instead of AUSF fetches 5G-GUTI and ngKSI from AMF and sends them to AUSF, which then sends them to the UE in EAP-AKA′. After a successful authentication, AUSF sends Kseaf (and SUPI) to AMF. Alternatively, AUSF sends Kseaf to NSWOF, which sends it to AMF. AMF also sends SNN to NSWOF.

Some embodiments involving security algorithm negotiation during enhanced NSWO authentication and key agreement procedures will now be described in the context of the authentication procedure for NSWO in 5GS specified in 3GPP TS 33.501 (v17.5.0) Annex S.

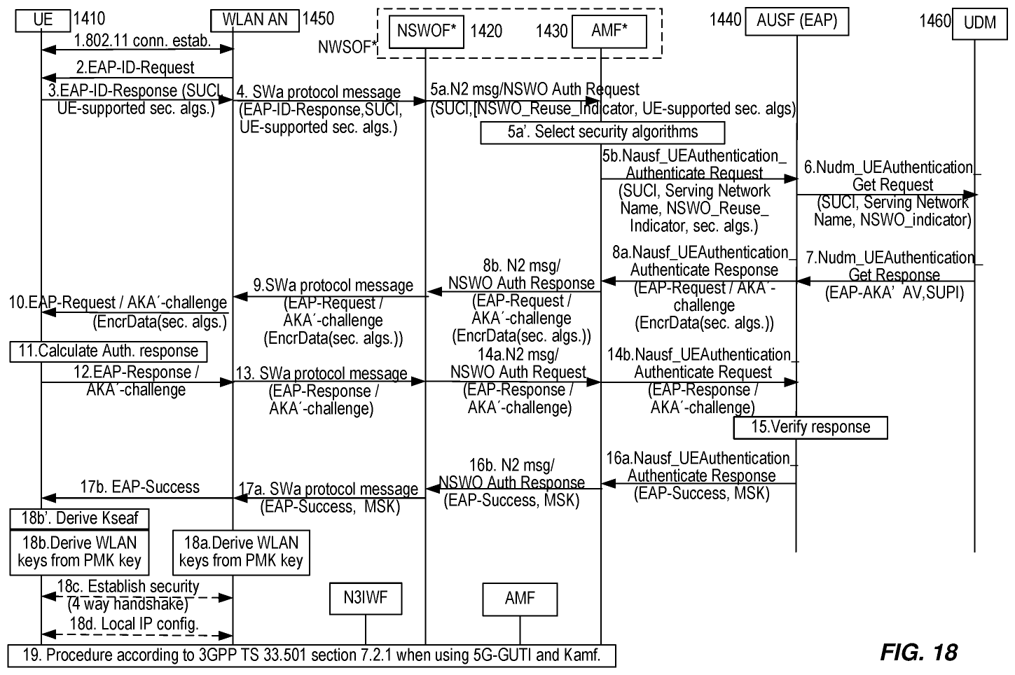

FIG. 18 shows a signaling diagram for an authentication procedure for NSWO in 5GS, according to some embodiments of the present disclosure. Although the operations shown in FIG. 18 are given numerical labels, this is intended to facilitate explanation rather than to require or imply any sequential order, unless express stated or unambiguously implied by a particular context.

The messages and/or operations shown in FIG. 18 are similar to ones with corresponding numbers in FIG. 16, except that certain message contents are different. In particular, rather than the UE sending a UEtoNW_reuse_indicator to NSWOF in operations 3-4, the UE instead sends an indication of UE-supported security algorithms. NSWOF includes this indicator in the message sent to AMF in operation 5a, and the selects security algorithm(s) from among the ones indicated as UE-supported (operation 5a′) and indicates the selection to AUSF (operation 5b).

The messages of operations 8a-10 include AMF-selected security algorithm(s) protected in the AT_ENCR_DATA parameter generated by AUSF. The UE can later use the chosen algorithms to protect NAS messages with AMF. Operations 11-19 are substantially similar to corresponding operations 11-19 in FIGS. 14 and 16.

Variants similar to ones discussed above in relation to FIGS. 14-17 can also be applied to the procedure shown in FIG. 18. For example, in some variants, NSWOF also takes on AMF's role, performing tasks shown as being performed by AMF in FIG. 18. This option is shown in FIG. 18 by the dashed box around NSWOF and AMF.

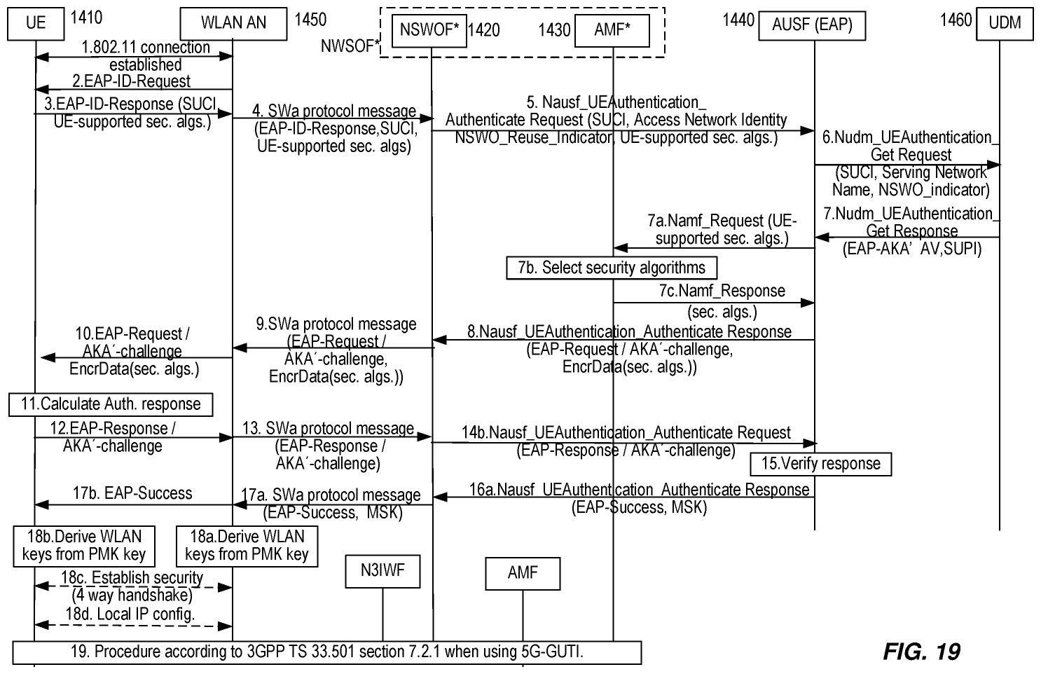

FIG. 19 shows a signaling diagram for an authentication procedure for NSWO in 5GS, according to other embodiments of the present disclosure. Although the operations shown in

FIG. 19 are given numerical labels, this is intended to facilitate explanation rather than to require or imply any sequential order, unless express stated or unambiguously implied by a particular context.

The messages and/or operations shown in FIG. 19 are similar to ones with corresponding numbers in FIG. 17, except that certain message contents are different. In particular, the UE sends an indication of UE-supported security algorithms to NSWOF in operations 3-4. NSWOF includes this indicator in the message sent to AUSF in operation 5, and AUSF includes this information in the request to AMF in operation 7a. AMF selects security algorithm(s) from among the ones indicated as UE-supported (operation 7b) and indicates the selection to AUSF (operation 7c). The messages of operations 8-10 include the AMF-selected security algorithm(s) protected in the AT_ENCR_DATA parameter generated by AUSF. The UE can later use the chosen algorithms to protect NAS messages with AMF. Operations 11-19 are substantially similar to corresponding operations 11-19 in FIGS. 15 and 17.

Variants similar to ones discussed above in relation to FIGS. 14-18 can also be applied to the procedure shown in FIG. 19. For example, in some variants, NSWOF also takes on AMF's role, performing tasks shown as being performed by AMF in FIG. 19. This option is shown in FIG. 19 by the dashed box around NSWOF and AMF.

Other embodiments can be employed to re-use existing messages to have less impact on existing nodes in 5GC. Instead of introducing new N2 messages specific to procedure between NSWOF and AMF (e.g., NSWO auth request/response messages), NSWOF and AMF can perform a registration procedure reusing mostly existing signaling/messages for that procedure. NSWOF exchanges NAS messages with AMF on behalf of the NSWO device and terminates NAS protocol stack, e.g., with NULL NAS SMC. In that manner, impact to existing N1/N2 interface handling in AMF is reduced.

FIG. 20 shows a signaling diagram for an authentication procedure for NSWO in 5GS, according to some embodiments of the present disclosure. Although the operations shown in FIG. 20 are given numerical labels, this is intended to facilitate explanation rather than to require or imply any sequential order, unless express stated or unambiguously implied by a particular context.

The procedure shown in FIG. 20 is substantially similar to the procedure shown in FIG. 16, except for the names of the messages in operations 5a, 8b, and 14a. Additionally, FIG. 16 operation 16b is replaced by two message exchanges: a NAS SMC Request/Response in operation 16b, and an Initial Context Setup Request/Response in operation 16c.

Variants similar to ones discussed above in relation to FIGS. 14-19 can also be applied to the procedure shown in FIG. 20. For example, in some variants, NSWOF also takes on AMF's role, performing tasks shown as being performed by AMF in FIG. 20. This option is shown in FIG. 20 by the dashed box around NSWOF and AMF.

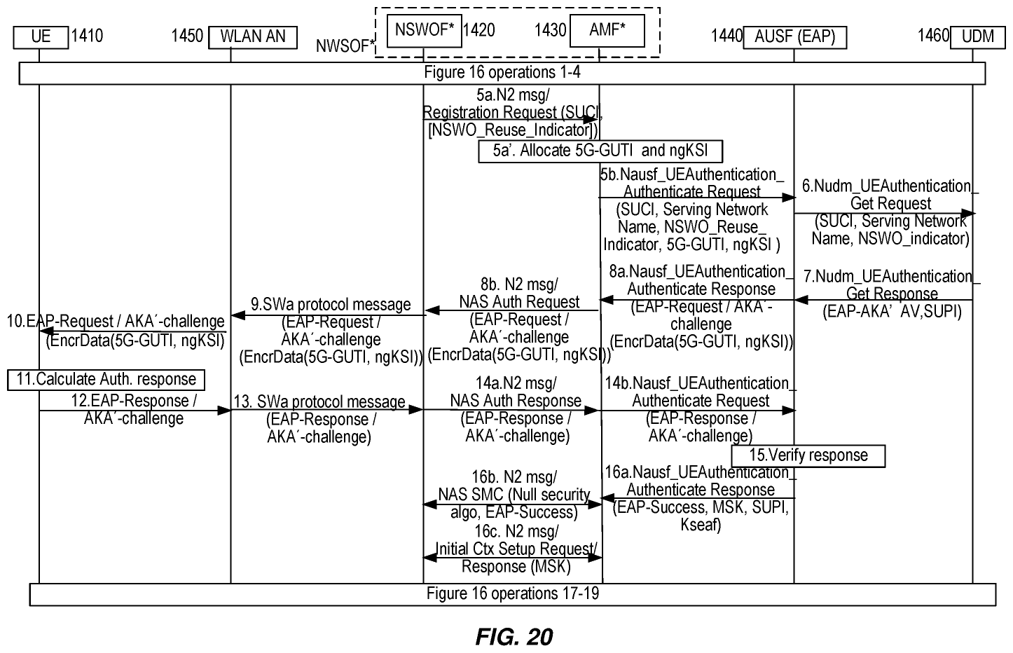

FIG. 21 shows a signaling diagram for an authentication procedure for NSWO in 5GS, according to other embodiments of the present disclosure. Although the operations shown in FIG. 21 are given numerical labels, this is intended to facilitate explanation rather than to require or imply any sequential order, unless express stated or unambiguously implied by a particular context.

Based on local policy or the indication from the UE that enhanced authentication is to be performed, NSWOF determines that a 5G extensible authentication protocol (EAP-5G) should be used with the UE. The use of EAP-5G with NAS messages is further specified in 3GPP TS 33.501 (v17.5.0). In the procedure shown in FIG. 21, AMF runs NAS SMC with the UE over NSWOF, which encapsulates NAS SMC procedure within EAP-5G. The allocated 5G-GUTI and/or ngKSI are sent from AMF to UE over NAS SMC, which is protected with Kseaf provided by AUSF in operation 16a.

Variants similar to ones discussed above in relation to FIGS. 14-20 can also be applied to the procedure shown in FIG. 21. For example, in some variants, the NSWOF also takes on AMF's role, performing tasks shown as being performed by AMF in FIG. 21. This option is shown in FIG. 21 by the dashed box around NSWOF and AMF.

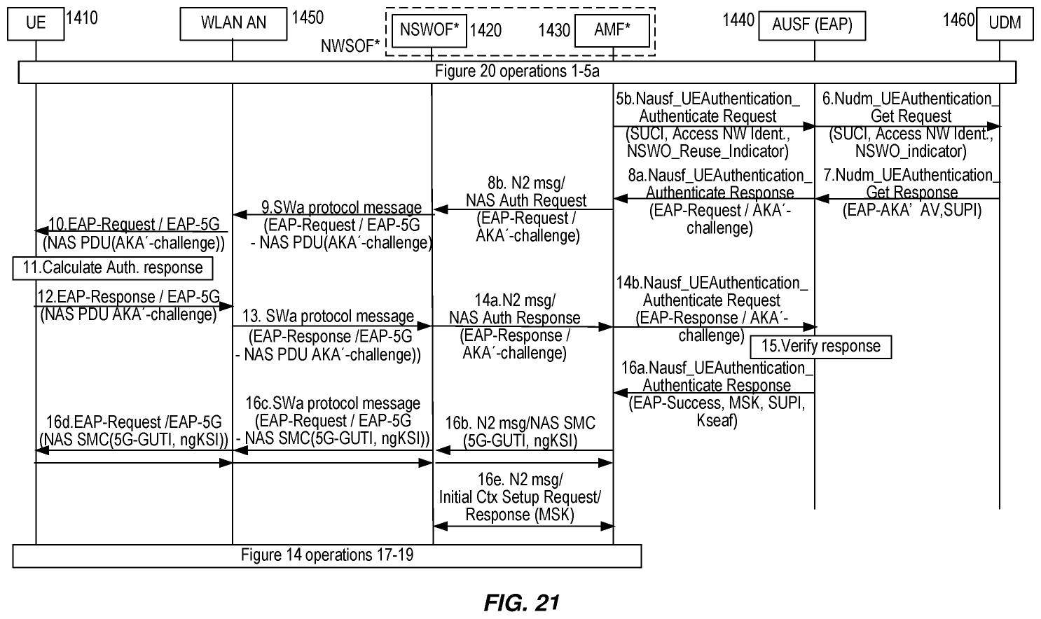

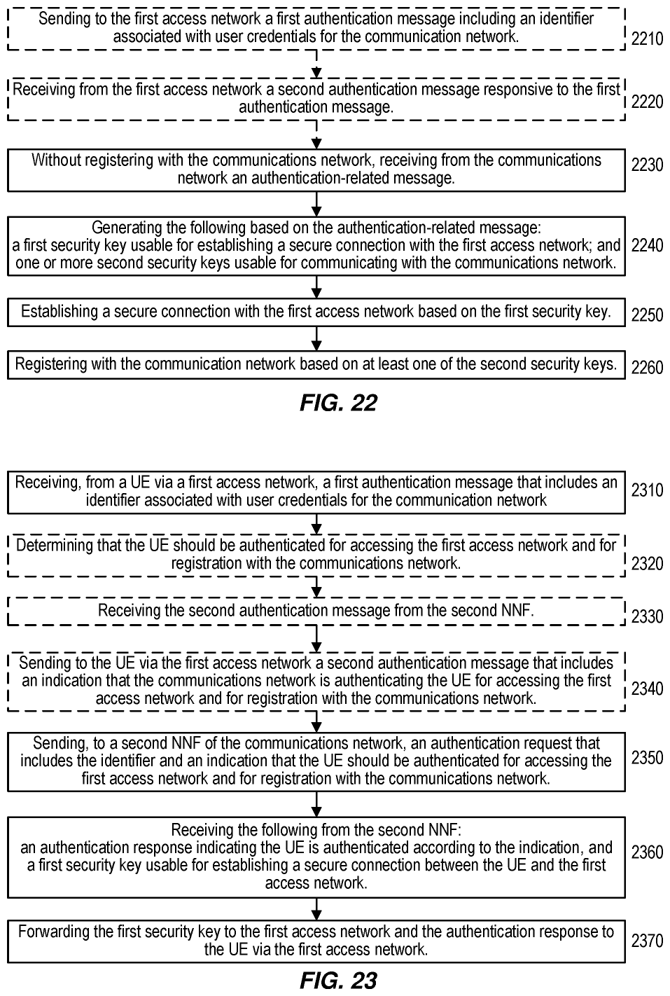

The embodiments described above are further illustrated by FIGS. 22-25, which depict exemplary methods (e.g., procedures) for a UE, a first network node or function (NNF), a second NNF, and a third NNF, respectively. Put differently, various features of the operations described below correspond to various embodiments described above, including the embodiments shown in FIGS. 14-21. The exemplary methods shown in FIGS. 22-25 can be used cooperatively (e.g., with each other and with other procedures described herein) to provide benefits, advantages, and/or solutions to problems described herein. Although the exemplary methods are illustrated in FIGS. 22-25 by specific blocks in particular orders, the operations corresponding to the blocks can be performed in different orders than shown and can be combined and/or divided into blocks and/or operations having different functionality than shown. Optional blocks and/or operations are indicated by dashed lines.

In particular, FIG. 22 illustrates an exemplary method (e.g., procedure) for a UE configured to communicate with a communications network (e.g., 5GC) via at least a first access network, according to various embodiments of the present disclosure. For example, the exemplary method shown in FIG. 22 can be performed by a UE (e.g., wireless device) such as described elsewhere herein.

The exemplary method can include the operations of block 2230, where without registering with the communications network, the UE can receive from the communications network an authentication-related message. The exemplary method can also include the operations of block 2240, where the UE can generate the following based on the authentication-related message: a first security key usable for establishing a secure connection with the first access network, and one or more second security keys usable for communicating with the communications network. The exemplary method can also include the operations of block 2250, where the UE can establish a secure connection with the first access network based on the first security key. The exemplary method can also include the operations of block 2260, where the UE can subsequently (e.g., after block 2250) register with the communications network based on at least one of the second security keys.

In some embodiments, the first security key is a master session key (MSK) or a non-seamless WLAN offload (NSWO) key, the communications network is a 5G network, and the one or more second security keys include K_{AUSF}, K_{SEAF}, and KAMF. In some of these embodiments, registering with the communications network in block 2260 is based on KAMF.

In some of these embodiments, the first access network is one of the following: a trusted WLAN, a trusted non-3GPP access network, or a non-trusted non-3GPP access network.

In some embodiments, the authentication-related message is an EAP-Request message or an EAP-Success message.

In some embodiments, the exemplary method can also include the operations of blocks 2210-2220, where the UE can send to the first access network a first authentication message including an identifier associated with user credentials for the communication network, and receive from the first access network a second authentication message responsive to the first authentication message.

In some of these embodiments, the first authentication message includes an indication that the UE is requesting authentication for accessing the first access network and for registration with the communications network. In other of these embodiments, the second authentication message includes an indication that the communications network is authenticating the UE for accessing the first access network and for registration with the communications network.

In some of these embodiments, the first authentication message is an EAP Response/Identity message and the second authentication message is an EAP-Request message. In some of these embodiments, the identifier associated with user credentials for the communications network is a SUCI.

In some embodiments, the authenticated-related message in block 2230 includes an identifier associated with the first access network, and generating the first security key and the one or more second security keys in block 2240 is based on the identifier associated with the first access network.

In some embodiments, registering with the communications network in block 2260 is via one of the following: the secure connection with the first access network, or a second access network different than the first access network.

In addition, FIG. 23 illustrates an exemplary method (e.g., procedure) for with a first NNF of a communications network (e.g., 5GC), according to various embodiments of the present disclosure. For example, the exemplary method shown in FIG. 23 can be performed by an NSWOF (or a network node hosting the same) such as described elsewhere herein.

The exemplary method can include the operations of blocks 2310, where the first NNF can receive, from a UE via a first access network, a first authentication message that includes an identifier associated with user credentials for the communication network. The exemplary method can include the operations of blocks 2350, where the first NNF can send, to a second NNF of the communications network, an authentication request that includes the identifier and an indication that the UE should be authenticated for accessing the first access network and for registration with the communications network. The exemplary method can include the operations of blocks 2360, where the first NNF can receive the following from the second NNF: an authentication response indicating that the UE is authenticated according to the indication, and a first security key usable for establishing a secure connection between the UE and the first access network. The exemplary method can include the operations of blocks 2370, where the first NNF can forward the first security key to the first access network and the authentication response to the UE via the first access network.

In some embodiments, the first access network is one of the following: a trusted wireless local area network (WLAN), a trusted non-3GPP access network, or a non-trusted non-3GPP access network. In some embodiments, the first security key is one of the following: a master session key (MSK), or a non-seamless wireless LAN (WLAN) offload (NSWO) key. In some embodiments, the first authentication message is an EAP Response/Identity message and the authentication response is an EAP-Success message.

In some embodiments, sending the authentication request in block 2350 is based on the operations of block 2320, where the first NNF can determine that the UE should be authenticated for accessing the first access network and for registration with the communications network. In some of these embodiments, determining in block 232 that the UE should be authenticated for accessing the first access network and for registration with the communications network is based on one of the following:
an indication that the UE is requesting authentication for accessing the first access network and for registration with the communications network, included in the first authentication message; or
local policy of the first NNF that each UE authentication should be for accessing the first access network and for registration with the communications network.

In some embodiments, the exemplary method can also include the operations of block 2340, where the first NNF can send to the UE via the first access network a second authentication message that includes an indication that the communications network is authenticating the UE for accessing the first access network and for registration with the communications network. In some of these embodiments, the second authentication message is an EAP-Request/message.

In some of these embodiments, sending the second authentication message is based on determining, based on local policy (e.g., in block 2320), that the UE should be authenticated for accessing the first access network and for registration with the communications network.; In other of these embodiments, the exemplary method also includes the operations of block 2330, where the first NNF can receive the second authentication message from the second NNF. In such case, the received second authentication message is forwarded to the UE via the first access network (e.g., in block 2340).

In some embodiments, the indication that the UE should be authenticated for accessing the first access network and for registration with the communications network is implicit from the authentication request sent to the second NNF. In some embodiments, the identifier associated with user credentials for the communication network is a subscription concealed identifier (SUCI).

In some embodiments, the communications network is a 5G network, the first NNF is an NSWOF, and the second NNF is one of the following: an AMF separate from the NSWOF, an AMF combined with the NSWOF, or an AUSF. FIGS. 14, 20, and 21 show examples of embodiments where the second NNF is an AMF, while FIG. 15 shows an example of embodiments where the second NNF is an AUSF. In some of these embodiments, the authentication request also includes an address of an AMF that supports registration of the UE with the communications network.

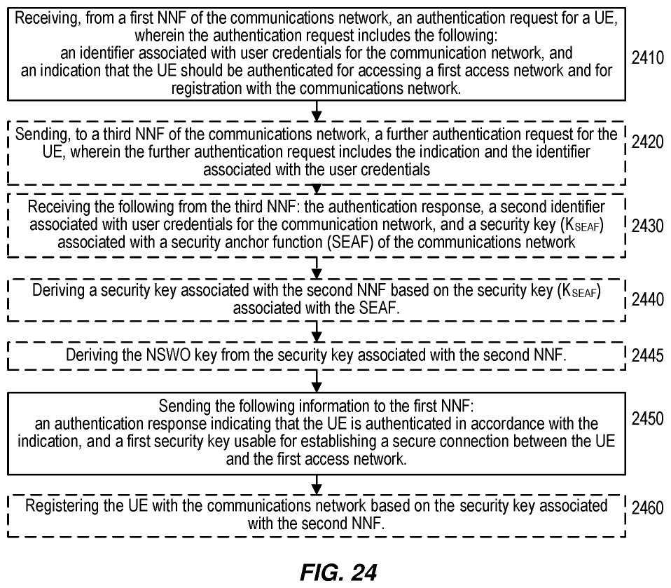

In addition, FIG. 24 illustrates an exemplary method (e.g., procedure) for with a second NNF of a communications network (e.g., 5GC), according to various embodiments of the present disclosure. For example, the exemplary method shown in FIG. 24 can be performed by an AMF (or a network node hosting the same or similar functionality) such as described elsewhere herein.

The exemplary method can include the operations of block 2410, where the second NNF can receive, from a first NNF of the communications network, an authentication request for a UE. The authentication request includes the following: an identifier associated with user credentials for the communication network, and an indication that the UE should be authenticated for accessing a first access network and for registration with the communications network. The exemplary method can include the operations of block 2450, where the second NNF can send the following information to the first NNF: an authentication response indicating that the UE is authenticated in accordance with the indication, and a first security key usable for establishing a secure connection between the UE and the first access network.

In some embodiments, the exemplary method can also include the following operations, labelled with corresponding block numbers:
(2420) sending, to a third NNF of the communications network, a further authentication request for the UE, wherein the further authentication request includes the indication and the identifier associated with the user credentials; and
(2430) receiving the following from the third NNF: the authentication response, a second identifier associated with user credentials for the communication network, and a security key (K_{SEAF}) associated with a security anchor function (SEAF) of the communications network; and
(2440) deriving a security key associated with the second NNF based on the security key (K_{SEAF}) associated with the SEAF.

In some embodiments, the communications network is a 5G network, the first NNF is an NSWOF, the second NNF is an AMF, and the third NNF is an AUSF. In some of these embodiments, the first access network is one of the following: a trusted WLAN, a trusted non-3GPP access network, or a non-trusted non-3GPP access network.

In some of these embodiments, the first security key is a master session key (MSK), which is also received from the AUSF. In other of these embodiments, wherein the first security key is an NSWO key and the exemplary method also includes the operations of block 2445, where the second NNF can derive the NSWO key from the security key associated with the second NNF.

In some of these embodiments, the identifier associated with user credentials is a SUCI and the second identifier associated with user credentials is a SUPI. In some of these embodiments, the indication that the UE should be authenticated for accessing the first access network and for registration with the communications network is implicit from the further authentication request sent to the third NNF. In some of these embodiments, the further authentication request also includes an address associated with the first NNF.

In some of these embodiments, the exemplary method can also include the operations of block 2460, where the second NNF can subsequently (e.g., after block 2450) register the UE with the communications network based on the security key associated with the second NNF.

In some embodiments, the first authentication message is an EAP Response/Identity message and the authentication response is an EAP-Success message. In some embodiments, the indication that the UE should be authenticated for accessing the first access network and for registration with the communications network is implicit from the authentication request received from the first NNF.

In some embodiments, the second NNF (e.g., AMF) is combined with the first NNF (e.g., NSWOF). In other embodiments, the second NNF (e.g., AMF) is separate from the first NNF (e.g., NSWOF).

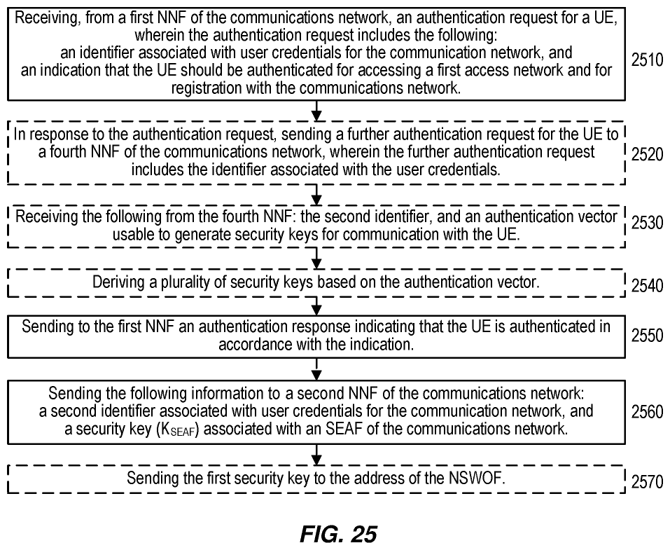

In addition, FIG. 25 illustrates an exemplary method (e.g., procedure) for a third NNF of a communications network (e.g., 5GC), according to various embodiments of the present disclosure. For example, the exemplary method shown in FIG. 25 can be performed by an AUSF (or a network node hosting the same or similar functionality) such as described elsewhere herein.

The exemplary method can include the operations of block 2510, where the third NNF can receive, from a first NNF of the communications network, an authentication request for a UE. The authentication request includes the following: an identifier associated with user credentials for the communication network, and an indication that the UE should be authenticated for accessing the WLAN and for registration with the communications network. The exemplary method can also include the operations of block 2550, where the third NNF can send to the first NNF an authentication response indicating that the UE is authenticated in accordance with the indication. The exemplary method can also include the operations of block 2560, where the third NNF can send the following information to a second NNF of the communications network: a second identifier associated with user credentials for the communication network, and a security key (K_{SEAF}) associated with a security anchor function (SEAF) of the communications network.

In some embodiments, the exemplary method can also include the following operations, labelled with corresponding block numbers:
(2520) in response to the authentication request, sending a further authentication request for the UE to a fourth NNF of the communications network, wherein the further authentication request includes the identifier associated with the user credentials;
(2530) receiving the following from the fourth NNF: the second identifier, and an authentication vector usable to generate security keys for communication with the UE; and
(2540) deriving the following based on the authentication vector: a first security key usable for establishing a secure connection between the UE and the first access network, the security key (K_{SEAF}) associated with the SEAF, and a security key associated with the third NNF.

In some of these embodiments, the authentication request and the further authentication request also include an identifier associated with the first access network. In some of these embodiments, the communications network is a 5G network, the second NNF is an AMF, the third NNF is an AUSF, and the fourth NNF is a UDM function.

In some variants of these embodiments, the first access network is one of the following: a trusted WLAN, a trusted non-3GPP access network, or a non-trusted non-3GPP access network.

In some variants of these embodiments, the first NNF is the AMF and the authentication response is sent to the AMF together with the second identifier and the security key (K_{SEAF}) associated with the SEAF. FIGS. 14, 20, and 21 show examples of these variants. In some further variants, the first security key is sent to the AMF together with the authentication response, the second identifier, and the security key (K_{SEAF}) associated with the SEAF. In other further variants, the authentication request also includes NSWOF associated with the communications network, and the exemplary method also includes the operations of block 2570, where the third NNF can send the first security key to the address of the NSWOF.

In other variants of these embodiments, the first NNF is a function (NSWOF). FIG. 15 shows an example of these variants. In some further variants, the first security key is sent to the NSWOF together with the authentication response. In some further variants, the authentication request also includes an address of the second NNF, and the second identifier and the security key (K_{SEAF}) associated with the SEAF are sent to the address of the second NNF.

In some embodiments, the identifier associated with user credentials is a subscription concealed identifier (SUCI) and the second identifier associated with user credentials is a subscription public identifier (SUPI). In some embodiments, the indication that the UE should be authenticated for accessing the WLAN and for registration with the communications network is implicit from the authentication request received from the first NF. In some embodiments, the first security key is a master session key (MSK).

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

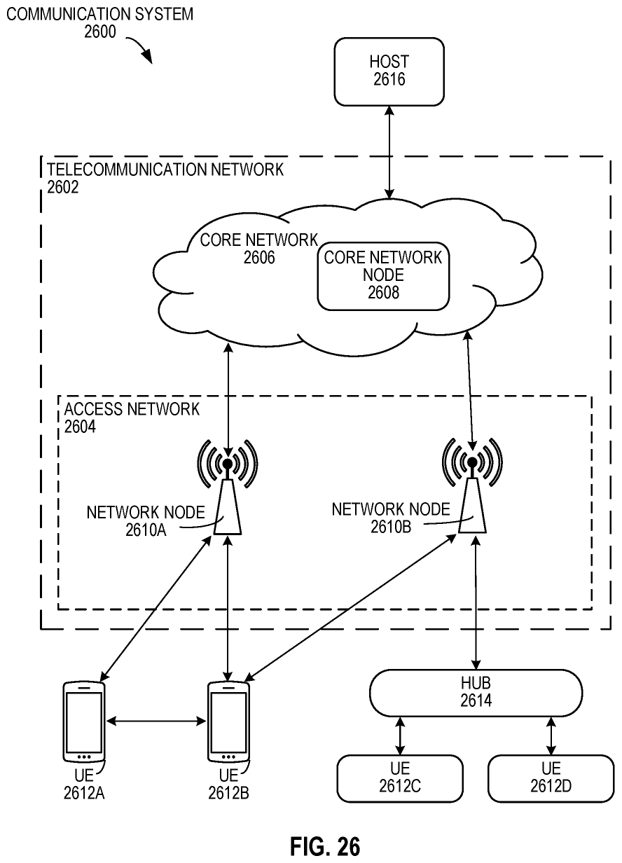

FIG. 26 shows an example of a communication system 2600 in accordance with some embodiments. In this example, communication system 2600 includes a telecommunication network 2602 that includes an access network 2604 (e.g., RAN) and a core network 2606, which includes one or more core network nodes 2608. Access network 2604 includes one or more access network nodes, such as network nodes 2610a-b (one or more of which may be generally referred to as network nodes 2610), or any other similar 3GPP access node or non-3GPP access point. Network nodes 2610 facilitate direct or indirect connection of user UEs, such as by connecting UEs 2612a-d (one or more of which may be generally referred to as UEs 2612) to core network 2606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 2600 may include any number of wired or wireless networks, network nodes, UEs, and/or any other components or systems that may facilitate or participate in the communication of data and/or signals whether via wired or wireless connections. Communication system 2600 may include and/or interface with any type of communication, telecommunication, data, cellular, radio network, and/or other similar type of system.

UEs 2612 may be any of a wide variety of communication devices, including wireless devices arranged, configured, and/or operable to communicate wirelessly with network nodes 2610 and other communication devices. Similarly, network nodes 2610 are arranged, capable, configured, and/or operable to communicate directly or indirectly with UEs 2612 and/or with other network nodes or equipment in telecommunication network 2602 to enable and/or provide network access, such as wireless network access, and/or to perform other functions, such as administration in telecommunication network 2602.

In the depicted example, core network 2606 connects network nodes 2610 to one or more hosts, such as host 2616. These connections may be direct or indirect via one or more intermediary networks or devices. In other examples, network nodes may be directly coupled to hosts. Core network 2606 includes one or more core network nodes (e.g., 2608) that are structured with hardware and software components. Features of these components may be substantially similar to those described with respect to the UEs, network nodes, and/or hosts, such that the descriptions thereof are generally applicable to the corresponding components of core network node 2608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 2616 may be under the ownership or control of a service provider other than an operator or provider of access network 2604 and/or telecommunication network 2602, and may be operated by the service provider or on behalf of the service provider. Host 2616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 2600 of FIG. 26 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 2602 is a cellular network that implements 3GPP standardized features. Accordingly, telecommunication network 2602 may support network slicing to provide different logical networks to different devices that are connected to telecommunication network 2602. For example, telecommunication network 2602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 2612 are configured to transmit and/or receive information without direct human interaction. For instance, a UE may be designed to transmit information to access network 2604 on a predetermined schedule, when triggered by an internal or external event, or in response to requests from access network 2604. Additionally, a UE may be configured for operating in single-or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, hub 2614 communicates with access network 2604 to facilitate indirect communication between one or more UEs (e.g., UE 2612c and/or 2612d) and network nodes (e.g., network node 2610b). In some examples, hub 2614 may be a controller, router, content source and analytics, or any of the other communication devices described herein regarding UEs. For example, hub 2614 may be a broadband router enabling access to core network 2606 for the UEs. As another example, hub 2614 may be a controller that sends commands or instructions to one or more actuators in the UEs. Commands or instructions may be received from the UEs, network nodes 2610, or by executable code, script, process, or other instructions in hub 2614. As another example, hub 2614 may be a data collector that acts as temporary storage for UE data and, in some embodiments, may perform analysis or other processing of the data. As another example, hub 2614 may be a content source. For example, for a UE that is a VR headset, display, loudspeaker or other media delivery device, hub 2614 may retrieve VR assets, video, audio, or other media or data related to sensory information via a network node, which hub 2614 then provides to the UE either directly, after performing local processing, and/or after adding additional local content. In still another example, hub 2614 acts as a proxy server or orchestrator for the UEs, in particular in if one or more of the UEs are low energy IoT devices.

Hub 2614 may have a constant/persistent or intermittent connection to network node 2610b. Hub 2614 may also allow for a different communication scheme and/or schedule between hub 2614 and UEs (e.g., UE 2612c and/or 2612d), and between hub 2614 and core network 2606. In other examples, hub 2614 is connected to core network 2606 and/or one or more UEs via a wired connection. Moreover, hub 2614 may be configured to connect to an M2M service provider over access network 2604 and/or to another UE over a direct connection. In some scenarios, UEs may establish a wireless connection with network nodes 2610 while still connected via hub 2614 via a wired or wireless connection. In some embodiments, hub 2614 may be a dedicated hub—that is, a hub whose primary function is to route communications to/from the UEs from/to network node 2610b. In other embodiments, hub 2614 may be a non-dedicated hub—that is, a device which is capable of operating to route communications between the UEs and network node 2610b, but which is additionally capable of operating as a communication start and/or end point for certain data channels.

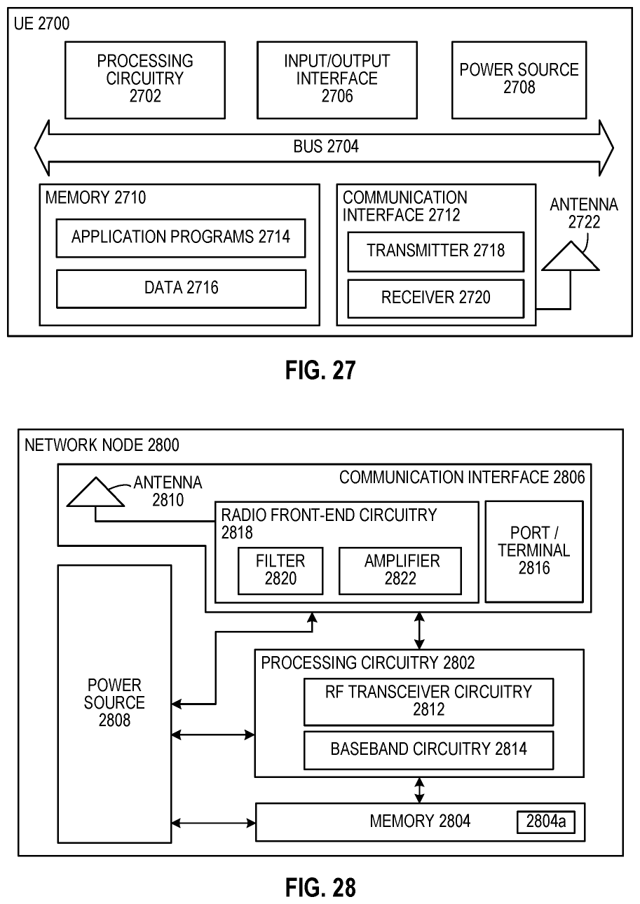

FIG. 27 shows a UE 2700 in accordance with some embodiments. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 2700 includes processing circuitry 2702 that is operatively coupled via bus 2704 to input/output interface 2706, power source 2708, memory 2710, communication interface 2712, and/or any other component, or any combination thereof. Certain UEs may utilize all or a subset of the components shown in FIG. 27. The level of integration between the components may vary from one UE to another UE. Further, certain UEs may contain multiple instances of a component, such as multiple processors, memories, transceivers, transmitters, receivers, etc.

Processing circuitry 2702 is configured to process instructions and data and may be configured to implement any sequential state machine operative to execute instructions stored as machine-readable computer programs in memory 2710. Processing circuitry 2702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 2702 may include multiple central processing units (CPUs).

In the example, input/output interface 2706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 2700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 2708 is structured as a battery or battery pack. Other types of power sources, such as an external power source (e.g., an electricity outlet), photovoltaic device, or power cell, may be used. Power source 2708 may further include power circuitry for delivering power from power source 2708 itself, and/or an external power source, to the various parts of UE 2700 via input circuitry or an interface such as an electrical power cable. Delivering power may be, for example, for charging of power source 2708. Power circuitry may perform any formatting, converting, or other modification to the power from power source 2708 to make the power suitable for the respective components of UE 2700 to which power is supplied.

Memory 2710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 2710 includes one or more application programs 2714, such as an operating system, web browser application, a widget, gadget engine, or other application, and corresponding data 2716. Memory 2710 may store, for use by UE 2700, any of a variety of various operating systems or combinations of operating systems.

Memory 2710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 2710 may allow UE 2700 to access instructions, application programs and the like, stored on transitory or non-transitory memory media, to off-load data, or to upload data. An article of manufacture, such as one utilizing a communication system may be tangibly embodied as or in memory 2710, which may be or comprise a device-readable storage medium.

Processing circuitry 2702 may be configured to communicate with an access network or other network using communication interface 2712. Communication interface 2712 may comprise one or more communication subsystems and may include or be communicatively coupled to an antenna 2722. Communication interface 2712 may include one or more transceivers used to communicate, such as by communicating with one or more remote transceivers of another device capable of wireless communication (e.g., another UE or a network node in an access network). Each transceiver may include transmitter 2718 and/or receiver 2720 appropriate to provide network communications (e.g., optical, electrical, frequency allocations, and so forth). Moreover, transmitter 2718 and receiver 2720 may be coupled to one or more antennas (e.g., 2722) and may share circuit components, software or firmware, or alternatively be implemented separately.

In the illustrated embodiment, communication functions of communication interface 2712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 2700 shown in FIG. 27.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 28 shows a network node 2800 in accordance with some embodiments. Examples of network nodes include, but are not limited to, access points (e.g., radio access points) and base stations (e.g., radio base stations, Node Bs, eNBs, and gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 2800 includes processing circuitry 2802, memory 2804, communication interface 2806, and power source 2808. Network node 2800 may be composed of multiple physically separate components (e.g., a NodeB component and a RNC component, or a BTS component and a BSC component, etc.), which may each have their own respective components. In certain scenarios in which network node 2800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 2800 may be configured to support multiple radio access technologies (RATs). In such embodiments, some components may be duplicated (e.g., separate memory 2804 for different RATs) and some components may be reused (e.g., a same antenna 2810 may be shared by different RATs). Network node 2800 may also include multiple sets of the various illustrated components for different wireless technologies integrated into network node 2800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2800.

Processing circuitry 2802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2800 components, such as memory 2804, to provide network node 2800 functionality.

In some embodiments, processing circuitry 2802 includes a system on a chip (SOC). In some embodiments, processing circuitry 2802 includes one or more of radio frequency (RF) transceiver circuitry 2812 and baseband processing circuitry 2814. In some embodiments, RF transceiver circuitry 2812 and baseband processing circuitry 2814 may be on separate chips (or sets of chips), boards, or units, such as radio units and digital units. In alternative embodiments, part or all of RF transceiver circuitry 2812 and baseband processing circuitry 2814 may be on the same chip or set of chips, boards, or units.

Memory 2804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 2802.

Memory 2804 may store any suitable instructions, data, or information, including a computer program, software, an application including one or more of logic, rules, code, tables, and/or other instructions (collectively denoted computer program 2804a, which may be in the form of a computer program product) capable of being executed by processing circuitry 2802 and utilized by network node 2800. Memory 2804 may be used to store any calculations made by processing circuitry 2802 and/or any data received via communication interface 2806. In some embodiments, processing circuitry 2802 and memory 2804 is integrated.

Communication interface 2806 is used in wired or wireless communication of signaling and/or data between a network node, access network, and/or UE. As illustrated, communication interface 2806 comprises port(s)/terminal(s) 2816 to send and receive data, for example to and from a network over a wired connection. Communication interface 2806 also includes radio front-end circuitry 2818 that may be coupled to, or in certain embodiments a part of, antenna 2810. Radio front-end circuitry 2818 comprises filters 2820 and amplifiers 2822. Radio front-end circuitry 2818 may be connected to antenna 2810 and processing circuitry 2802. The radio front-end circuitry may be configured to condition signals communicated between antenna 2810 and processing circuitry 2802. Radio front-end circuitry 2818 may receive digital data that is to be sent out to other network nodes or UEs via a wireless connection. Radio front-end circuitry 2818 may convert the digital data into a radio signal having the appropriate channel and bandwidth parameters using a combination of filters 2820 and/or amplifiers 2822. The radio signal may then be transmitted via antenna 2810. Similarly, when receiving data, antenna 2810 may collect radio signals which are then converted into digital data by radio front-end circuitry 2818. The digital data may be passed to processing circuitry 2802. In other embodiments, the communication interface may comprise different components and/or different combinations of components.

In certain alternative embodiments, network node 2800 does not include separate radio front-end circuitry 2818, instead, processing circuitry 2802 includes radio front-end circuitry and is connected to antenna 2810. Similarly, in some embodiments, all or some of the RF transceiver circuitry 2812 is part of communication interface 2806. In still other embodiments, communication interface 2806 includes one or more ports or terminals 2816, radio front-end circuitry 2818, and the RF transceiver circuitry 2812, as part of a radio unit (not shown), and communication interface 2806 communicates with baseband processing circuitry 2814, which is part of a digital unit (not shown).

Antenna 2810 may include one or more antennas, or antenna arrays, configured to send and/or receive wireless signals. Antenna 2810 may be coupled to radio front-end circuitry 2818 and may be any type of antenna capable of transmitting and receiving data and/or signals wirelessly. In certain embodiments, antenna 2810 is separate from network node 2800 and connectable to network node 2800 through an interface or port.

Antenna 2810, communication interface 2806, and/or processing circuitry 2802 may be configured to perform any receiving operations and/or certain obtaining operations described herein as being performed by the network node. Any information, data and/or signals may be received from a UE, another network node and/or any other network equipment. Similarly, antenna 2810, communication interface 2806, and/or processing circuitry 2802 may be configured to perform any transmitting operations described herein as being performed by the network node. Any information, data and/or signals may be transmitted to a UE, another network node and/or any other network equipment.

Power source 2808 provides power to the various components of network node 2800 in a form suitable for the respective components (e.g., at a voltage and current level needed for each respective component). Power source 2808 may further comprise, or be coupled to, power management circuitry to supply the components of network node 2800 with power for performing the functionality described herein. For example, network node 2800 may be connectable to an external power source (e.g., the power grid, an electricity outlet) via an input circuitry or interface such as an electrical cable, whereby the external power source supplies power to power circuitry of power source 2808. As a further example, power source 2808 may comprise a source of power in the form of a battery or battery pack which is connected to, or integrated in, power circuitry. The battery may provide backup power should the external power source fail.

Embodiments of network node 2800 may include additional components beyond those shown in FIG. 28 for providing certain aspects of the network node's functionality, including any of the functionality described herein and/or any functionality necessary to support the subject matter described herein. For example, network node 2800 may include user interface equipment to allow input of information into network node 2800 and to allow output of information from network node 2800. This may allow a user to perform diagnostic, maintenance, repair, and other administrative functions for network node 2800.

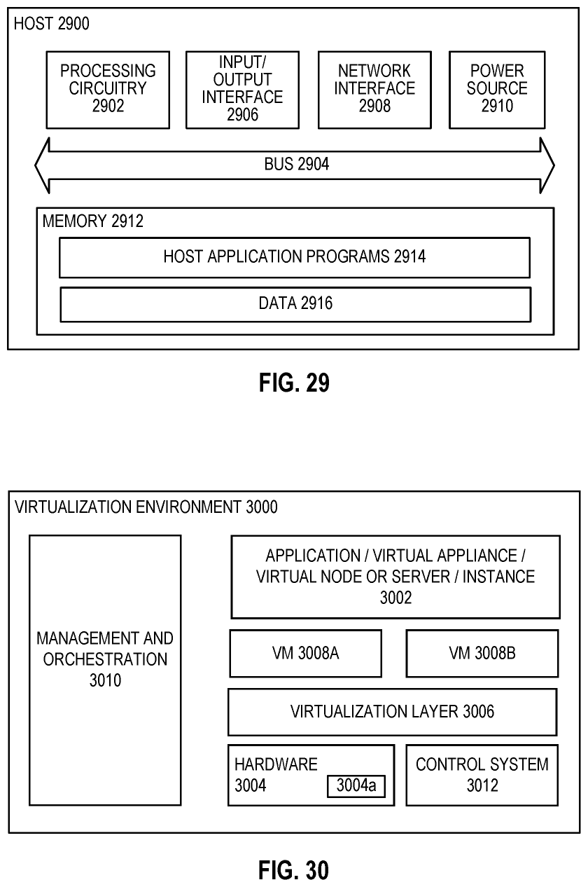

FIG. 29 is a block diagram of a host 2900, which may be an embodiment of host 2616 of FIG. 26, in accordance with various aspects described herein. As used herein, host 2900 may be or comprise various combinations hardware and/or software, including a standalone server, a blade server, a cloud-implemented server, a distributed server, a virtual machine, container, or processing resources in a server farm. Host 2900 may provide one or more services to one or more UEs.

Host 2900 includes processing circuitry 2902 that is operatively coupled via a bus 2904 to input/output interface 2906, network interface 2908, power source 2910, and memory 2912. Other components may be included in other embodiments. Features of these components may be substantially similar to those described with respect to the devices of previous figures, such as FIGS. 27 and 28, such that the descriptions thereof are generally applicable to the corresponding components of host 2900.

Memory 2912 may include one or more computer programs including one or more host application programs 2914 and data 2916, which may include user data, e.g., data generated by a UE for host 2900 or data generated by host 2900 for a UE. Embodiments of host 2900 may utilize only a subset or all of the components shown. Host application programs 2914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 2914 may also provide for user authentication and licensing checks and may periodically report health, routes, and content availability to a central node, such as a device in or on the edge of a core network. Accordingly, host 2900 may select and/or indicate a different host for over-the-top services for a UE. Host application programs 2914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 30 is a block diagram illustrating a virtualization environment 3000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 3000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 3002 (which may alternatively be called software instances, virtual appliances, network functions, virtual nodes, virtual network functions, etc.) are run in the virtualization environment 2900 to implement some of the features, functions, and/or benefits of some of the embodiments disclosed herein.

Hardware 3004 includes processing circuitry, memory that stores software and/or instructions (collectively denoted computer program 3004a, which may be in the form of a computer program product) executable by hardware processing circuitry, and/or other hardware devices as described herein, such as a network interface, input/output interface, and so forth. Software may be executed by the processing circuitry to instantiate one or more virtualization layers 3006 (also referred to as hypervisors or virtual machine monitors (VMMs)), provide VMs 3008a-b (one or more of which may be generally referred to as VMs 3008), and/or perform any of the functions, features and/or benefits described in relation with some embodiments described herein. Virtualization layer 3006 may present a virtual operating platform that appears like networking hardware to the VMs 3008.

VMs 3008 comprise virtual processing, virtual memory, virtual networking or interface and virtual storage, and may be run by a corresponding virtualization layer 3006. Different embodiments of the instance of virtual appliance 3002 may be implemented on one or more of VMs 3008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 3008 may be a software implementation of a physical machine that runs programs as if they were executing on a physical, non-virtualized machine. Each VM 3008, and that part of hardware 3004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 3008 on top of hardware 3004 and corresponds to application 3002.

Hardware 3004 may be implemented in a standalone network node with generic or specific components. Hardware 3004 may implement some functions via virtualization. Alternatively, hardware 3004 may be part of a larger cluster of hardware (e.g., such as in a data center or CPE) where many hardware nodes work together and are managed via management and orchestration 3010, which, among others, oversees lifecycle management of applications 3002. In some embodiments, hardware 3004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 3012 which may alternatively be used for communication between hardware nodes and radio units.

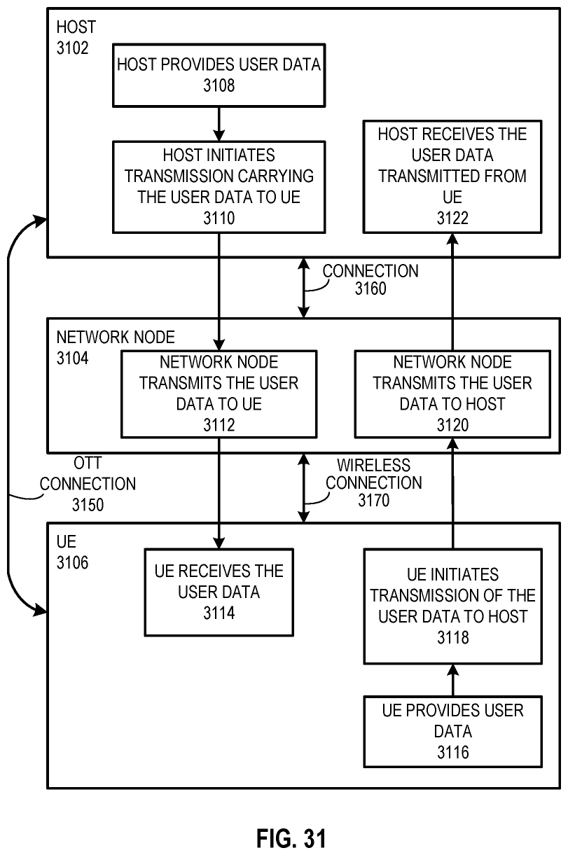

FIG. 31 shows a communication diagram of a host 3102 communicating via a network node 3104 with a UE 3106 over a partially wireless connection in accordance with some embodiments. Example implementations, in accordance with various embodiments, of the UE (such as a UE 2612a of FIG. 26 and/or UE 2700 of FIG. 27), network node (such as network node 2610a of FIG. 26 and/or network node 2800 of FIG. 28), and host (such as host 2616 of FIG. 26 and/or host 2900 of FIG. 29) discussed in the preceding paragraphs will now be described with reference to FIG. 31.

Like host 2900, embodiments of host 3102 include hardware, such as a communication interface, processing circuitry, and memory. Host 3102 also includes software, which is stored in or accessible by host 3102 and executable by the processing circuitry. The software includes a host application that may be operable to provide a service to a remote user, such as UE 3106 connecting via an over-the-top (OTT) connection 3150 extending between UE 3106 and host 3102. In providing the service to the remote user, a host application may provide user data which is transmitted using OTT connection 3150.

Network node 3104 includes hardware enabling it to communicate with host 3102 and UE 3106. Connection 3160 may be direct or pass through a core network (like core network 2606 of FIG. 26) and/or one or more other intermediate networks, such as one or more public, private, or hosted networks. For example, an intermediate network may be a backbone network or the Internet.

UE 3106 includes hardware and software, which is stored in or accessible by UE 3106 and executable by the UE's processing circuitry. The software includes a client application, such as a web browser or operator-specific “app” that may be operable to provide a service to a human or non-human user via UE 3106 with the support of host 3102. In host 3102, an executing host application may communicate with the executing client application via OTT connection 3150 terminating at UE 3106 and host 3102. In providing the service to the user, the UE's client application may receive request data from the host's host application and provide user data in response to the request data. OTT connection 3150 may transfer both the request data and the user data. The UE's client application may interact with the user to generate the user data that it provides to the host application through OTT connection 3150.

OTT connection 3150 may extend via a connection 3160 between host 3102 and network node 3104 and via a wireless connection 3170 between network node 3104 and UE 3106 to provide the connection between host 3102 and UE 3106. Connection 3160 and wireless connection 3170, over which OTT connection 3150 may be provided, have been drawn abstractly to illustrate the communication between host 3102 and UE 3106 via network node 3104, without explicit reference to any intermediary devices and the precise routing of messages via these devices.

As an example of transmitting data via OTT connection 3150, in step 3108, host 3102 provides user data, which may be performed by executing a host application. In some embodiments, the user data is associated with a particular human user interacting with UE 3106. In other embodiments, the user data is associated with a UE 3106 that shares data with host 3102 without explicit human interaction. In step 3110, host 3102 initiates a transmission carrying the user data towards UE 3106. Host 3102 may initiate the transmission responsive to a request transmitted by UE 3106. The request may be caused by human interaction with UE 3106 or by operation of the client application executing on UE 3106. The transmission may pass via network node 3104, in accordance with the teachings of the embodiments described throughout this disclosure. Accordingly, in step 3112, network node 3104 transmits to UE 3106 the user data that was carried in the transmission that host 3102 initiated, in accordance with the teachings of the embodiments described throughout this disclosure. In step 3114, UE 3106 receives the user data carried in the transmission, which may be performed by a client application executed on UE 3106 associated with the host application executed by host 3102.

In some examples, UE 3106 executes a client application which provides user data to host 3102. The user data may be provided in reaction or response to the data received from host 3102. Accordingly, in step 3116, UE 3106 may provide user data, which may be performed by executing the client application. In providing the user data, the client application may further consider user input received from the user via an input/output interface of UE 3106. Regardless of the specific manner in which the user data was provided, UE 3106 initiates, in step 3118, transmission of the user data towards host 3102 via network node 3104. In step 3120, in accordance with the teachings of the embodiments described throughout this disclosure, network node 3104 receives user data from UE 3106 and initiates transmission of the received user data towards host 3102. In step 3122, host 3102 receives the user data carried in the transmission initiated by UE 3106.

One or more of the various embodiments improve the performance of OTT services provided to UE 3106 using OTT connection 3150, in which wireless connection 3170 forms the last segment. More precisely, embodiments described herein can provide various benefits and/or advantages useful for OTT services. For example, since only one authentication procedure is needed for a UE, embodiments can reduce the signaling between UE and involved network entities, as well as processing load in UE and involved network entities, relative to conventional techniques that require two authentication procedures. Additionally, embodiments facilitate smaller delay when a UE registers to 5GC since the UE's NAS security context is already available from earlier access-related authentication. By reducing registration delay for users and network signaling/processing resources needed for registration, embodiments improve the delivery of OTT services via WLAN access network, thereby increasing the value of OTT services to end users and service providers.

In an example scenario, factory status information may be collected and analyzed by host 3102. As another example, host 3102 may process audio and video data which may have been retrieved from a UE for use in creating maps. As another example, host 3102 may collect and analyze real-time data to assist in controlling vehicle congestion (e.g., controlling traffic lights). As another example, host 3102 may store surveillance video uploaded by a UE. As another example, host 3102 may store or control access to media content such as video, audio, VR or AR which it can broadcast, multicast or unicast to UEs. As other examples, host 3102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring OTT connection 3150 between host 3102 and UE 3106, in response to variations in the measurement results. The measurement procedure and/or the network functionality for reconfiguring the OTT connection may be implemented in software and hardware of host 3102 and/or UE 3106. In some embodiments, sensors (not shown) may be deployed in or in association with other devices through which OTT connection 3150 passes; the sensors may participate in the measurement procedure by supplying values of the monitored quantities exemplified above, or supplying values of other physical quantities from which software may compute or estimate the monitored quantities. The reconfiguring of OTT connection 3150 may include message format, retransmission settings, preferred routing etc.; the reconfiguring need not directly alter the operation of network node 3104. Such procedures and functionalities may be known and practiced in the art. In certain embodiments, measurements may involve proprietary UE signaling that facilitates measurements of throughput, propagation times, latency and the like, by host 3102. The measurements may be implemented in that software causes messages to be transmitted, in particular empty or ‘dummy’ messages, using OTT connection 3150 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

The techniques and apparatus described herein include, but are not limited to, the following enumerated examples:
A1. A method for a user equipment (UE) configured to communicate with a communications network via a wireless local access network (WLAN), the method comprising:
   obtaining the following from the communications network without registering with the communications network:
      authorization to connect to the WLAN based on user credentials for the communications network, and
      information that enables subsequent registration with the communications network;
   establishing a secure connection with the WLAN based on the received authorization; and
   subsequently registering with the communications network, via the secure WLAN connection, using the obtained information.
A2. The method of embodiment A1, wherein the received information includes one of the following:
   a temporary UE identifier and/or a security key identifier; or an indication of security algorithms to use for communication with the communications network.
A3. The method of any of embodiments A1-A2, further comprising sending, to the WLAN, an authorization request including an identifier associated with the user credentials for the communication network, and one of the following:
   an indication that the authorization request is for accessing both the WLAN and the communications network; or
   an indication of security algorithms supported by the UE for communication with the communications network,
   wherein the authorization and the information are obtained in response to the authorization request.
A4. The method of any of embodiments A1-A3, further comprising deriving one or more security keys based on the obtained information, wherein registering with the communications network is based on the derived security keys.
A5. The method of any of embodiments A1-A4, wherein:
   the authorization to connect to the WLAN includes a master session key (MSK);
   the method further comprises deriving one or more further security keys based on the MSK; and
   establishing a secure connection with the WLAN is based on the derived further security keys.
B1. A method for a non-seamless wireless LAN offload function (NSWOF) associated with a communications network, the method:
   receiving, from a user equipment (UE), an authorization request including an identifier associated with the user credentials for the communication network;
   sending, to a first network function (NF) of the communications network, a first request that includes the identifier and an indication that the first request is for the UE to access both the WLAN and the communications network;
   receiving, from the first NF, one or more responses that include the following:
      authorization for the UE to connect to the WLAN based on user credentials for the communications network, and
      information that enables subsequent UE registration with the communications network;
   forwarding the received authorization to the WLAN and the received information to the UE via the WLAN.
B2. The method of embodiment B1, wherein the received information includes one of the following:
   a temporary UE identifier and/or a security key identifier; or
   an indication of security algorithms to use for communication with the communications network.
B3. The method of any of embodiments B1-B2, wherein the authorization to connect to the WLAN includes a master session key (MSK).
B4. The method of any of embodiments B1-B3, wherein the authorization request also includes one of the following:
   an indication that the authorization request is for accessing both the WLAN and the communications network; or
   an indication of security algorithms supported by the UE for communication with the communications network.
B5. The method of any of embodiments B1-B4, wherein the first NF is one of the following: an access and mobility management function (AMF), or an authentication support function (AUSF).
C1. A method for an access and mobility management function (AMF) of a communications network, the method comprising:
   receiving, from a non-seamless wireless LAN offload function (NSWOF) associated with the communications network, a first request that includes a first identifier associated with user credentials for the communication network and an indication that the first request is for a user equipment (UE) to access both the WLAN and the communications network; and
   sending, to the NSWOF, one or more responses that includes the following:
      authorization for the UE to connect to the WLAN based on user credentials for the communications network, and
      information that enables subsequent UE registration with the communications network.
C1a. The method of embodiment C2, wherein the authorization for the UE to connect to the WLAN includes a master session key (MSK) for secure communication between the UE and the WLAN, and the one or more responses to the NSWOF include a second response that includes the MSK.
C2. The method of embodiment Cla, further comprising:
   sending, to an authentication server function (AUSF) of the communications network, an authentication request that includes the first identifier and the indication;
   receiving from the AUSF one or more authentication responses that include the following: the information that enables subsequent UE registration with the communications network, and the authorization for the UE to connect to the WLAN.
C3. The method of embodiment C2, wherein the one or more authentication responses include a second authentication response that includes the following: a second identifier associated with the user credentials for the communications network, and a security key for UE registration with the communications network.
C4. The method of embodiment C2, further comprising, in response to the first request, allocating or selecting one or more parameters for subsequent UE registration with the communications network, wherein:
   the authentication request also includes the allocated or selected parameters; and
   the one or more authentication responses include a first authentication response that includes an encrypted version of the allocated or selected parameters; and
   the one or more responses to the NSWOF include a first response that includes the encrypted version.
C5. The method of embodiment C4, wherein the allocated or selected parameters include one or more of the following: a second identifier associated with the user credentials, and a security key identifier.
C6. The method of embodiment C4, wherein:
   the first request also includes an indication of security algorithms supported by the UE for communication with the communications network; and
   the allocated or selected parameters include security algorithms for subsequent UE registration with the communications network.
C7. The method of any of embodiments C1-C6, further comprising subsequently registering the UE with the communications network using the information sent to the NSWOF.
D1. A method for an authentication server function (AUSF) associated with a communications network, the method comprising:
   receiving, from a first network function (NF) of the communications network, an authentication request that includes the following: a first identifier associated with user credentials for the communication network and an indication that the first request is for a user equipment (UE) to access both the WLAN and the communications network; and
   sending to the first NF one or more authentication responses that include the following:
      authorization for the UE to connect to the WLAN based on user credentials for the communications network, and
      information that enables subsequent UE registration with the communications network.
D2. The method of embodiment C1, wherein:
   the authorization for the UE to connect to the WLAN includes a master session key (MSK) for secure communication between the UE and the WLAN; and
   the one or more authentication responses include a second authentication response that includes the MSK.
D3. The method of embodiment D2, wherein the second authentication response also includes the following: a second identifier associated with the user credentials for the communications network, and a security key for UE registration with the communications network.
D4. The method of embodiment D3, wherein:
   the first NF is an access and mobility management function (AMF); and
   the authentication request also includes one or more parameters allocated or selected by the AMF for subsequent UE registration with the communications network.
D5. The method of embodiment D3, wherein:
   the first NF is a non-seamless wireless LAN offload function (NSWOF);
   the method further comprises obtaining, from an access and mobility management function (AMF) of the communication network, one or more parameters for subsequent UE registration with the communications network.
D6. The method of any of embodiments D4-D5, wherein the one or more authentication responses include a first authentication response that includes an encrypted version of the one or mor parameters.
D7. The method of embodiment D6, wherein the one or more parameters include the following: a second identifier associated with the user credentials, and a security key identifier.
D8. The method of embodiment D6, wherein the one or more parameters include security algorithms for subsequent UE registration with the communications network.
D9. The method of embodiment D2, wherein:
   the first NF is a non-seamless wireless LAN offload function (NSWOF);
   the authentication request also includes an address associated with an access and mobility management function (AMF) of the communication network, and
   the method further comprises sending, to the address associated with the AMF, a second identifier associated with the user credentials for the communications network and a security key for UE registration with the communications network.
E1. A user equipment (UE) configured to communicate with a communications network via a wireless local access network (WLAN), the UE comprising:
   communication interface circuitry configured to communicate via the WLAN; and
   processing circuitry operably coupled to the communication interface circuitry, whereby the processing circuitry and interface circuitry are configured to perform operations corresponding to any of the methods of embodiments A1-A5.
E2. A user equipment (UE) configured to communicate with a communications network via a wireless local access network (WLAN), the UE being further configured to perform operations corresponding to any of the methods of embodiments A1-A5.
E3. A non-transitory, computer-readable medium storing computer-executable instructions that, when executed by processing circuitry of a user equipment (UE) configured to communicate with a communications network via a wireless local access network (WLAN), configure the UE to perform operations corresponding to any of the methods of embodiments A1-A5.
E4. A computer program product comprising computer-executable instructions that, when executed by processing circuitry of a user equipment (UE) configured to communicate with a communications network via a wireless local access network (WLAN), configure the UE to perform operations corresponding to any of the methods of embodiments A1-A5.
F1. A non-seamless wireless LAN offload function (NSWOF) associated with a communications network, wherein:
   the NSWOF is implemented by communication interface circuitry and processing circuitry that are operably coupled; and
   the processing circuitry and interface circuitry are configured to perform operations corresponding to any of the methods of embodiments B1-B5.
F2. A non-seamless wireless LAN offload function (NSWOF) associated with a communications network, the NSWOF being configured to perform operations corresponding to any of the methods of embodiments B1-B5.
F3. A non-transitory, computer-readable medium storing computer-executable instructions that, when executed by processing circuitry associated with non-seamless wireless LAN offload function (NSWOF) associated with a communications network, configure the NSWOF to perform operations corresponding to any of the methods of embodiments B1-B5.
F4. A computer program product comprising computer-executable instructions that, when executed by processing circuitry associated with non-seamless wireless LAN offload function (NSWOF) associated with a communications network, configure the NSWOF to perform operations corresponding to any of the methods of embodiments B1-B5.
G1. An access and mobility management function (AMF) associated with a communications network, wherein:
   the AMF is implemented by communication interface circuitry and processing circuitry that are operably coupled; and
   the processing circuitry and interface circuitry are configured to perform operations corresponding to any of the methods of embodiments C1-C7.
G2. An access and mobility management function (AMF) associated with a communications network, the AMF being configured to perform operations corresponding to any of the methods of embodiments C1-C7.
G3. A non-transitory, computer-readable medium storing computer-executable instructions that, when executed by processing circuitry associated with an access and mobility management function (AMF) associated with a communications network, configure the CMNE to perform operations corresponding to any of the methods of embodiments C1-C7.
G4. A computer program product comprising computer-executable instructions that, when executed by processing circuitry associated with an access and mobility management function (AMF) associated with a communications network, configure the CMNE to perform operations corresponding to any of the methods of embodiments C1-C7.
H1. An authentication server function (AUSF) associated with a communications network, wherein:
   the AUSF is implemented by communication interface circuitry and processing circuitry that are operably coupled; and
   the processing circuitry and interface circuitry are configured to perform operations corresponding to any of the methods of embodiments D1-D9.
H2. An authentication server function (AUSF) associated with a communications network, the AUSF being configured to perform operations corresponding to any of the methods of embodiments D1-D9.
H3. A non-transitory, computer-readable medium storing computer-executable instructions that, when executed by processing circuitry associated with an authentication server function (AUSF) associated with a communications network, configure the AUSF to perform operations corresponding to any of the methods of embodiments D1-D9.
H4. A computer program product comprising computer-executable instructions that, when executed by processing circuitry associated with an authentication server function (AUSF) associated with a communications network, configure the AUSF to perform operations corresponding to any of the methods of embodiments D1-D9.

1.-73. (canceled)

74. A method for a user equipment (UE) configured to communicate with a communications network via at least a first access network, the method comprising:
without registering with the communications network, receiving from the communications network an authentication-related message;
generating the following based on the authentication-related message:
a first security key usable for establishing a secure connection with the first access network, and
one or more second security keys usable for communicating with the communications network;
establishing a secure connection with the first access network based on the first security key; and
registering with the communications network based on at least one of the second security keys.

75. The method of claim 74, wherein:
the first security key is a master session key (MSK) or a non-seamless wireless LAN offload (NSWO) key;
the communications network is a fifth-generation (5G) network; and
the one or more second security keys include K_{AUSF}, K_{SEAF}, and K_{AMF}.

76. The method of claim 75, wherein the first access network a trusted wireless local area network (WLAN), a trusted non-3GPP access network, or a non-trusted non-3GPP access network.

77. The method of claim 75, wherein registering with the communications network is based on K_{AMF}.

78. The method of claim 74, wherein the authentication-related message is an EAP-Request message or an EAP-Success message.

79. The method of claim 74, further comprising:
sending to the first access network a first authentication message including an identifier associated with user credentials for the communications network; and
receiving from the first access network a second authentication message responsive to the first authentication message.

80. The method of claim 79, wherein one of the following applies:
the first authentication message includes an indication that the UE is requesting authentication for accessing the first access network and for registration with the communications network; or
the second authentication message includes an indication that the communications network is authenticating the UE for accessing the first access network and for registration with the communications network.

81. The method of claim 79, wherein at least one of the following applies:
the first authentication message is an EAP Response/Identity message and the second authentication message is an EAP-Request message; and
the identifier associated with user credentials for the communications network is a subscription concealed identifier (SUCI).

82. The method of claim 74, wherein the authenticated-related message includes an identifier associated with the first access network, and generating the first security key and the one or more second security keys is based on the identifier associated with the first access network.

83. The method of claim 74, wherein registering with the communications network is via one of the following: the secure connection with the first access network, or a second access network different than the first access network.

84. A method for a first network node or function (NNF) of a communications network, the method:
receiving, from a user equipment (UE) via a first access network, a first authentication message that includes an identifier associated with user credentials for the communications network;
sending, to a second NNF of the communications network, an authentication request that includes the identifier and an indication that the UE should be authenticated for accessing the first access network and for registration with the communications network;
receiving the following from the second NNF:
an authentication response indicating that the UE is authenticated according to the indication, and
a first security key usable for establishing a secure connection between the UE and the first access network; and
forwarding the first security key to the first access network and the authentication response to the UE via the first access network.

85. The method of claim 84, wherein at least one of the following applies:
the first access network is a trusted wireless local area network (WLAN), a trusted non-3GPP access network, or a non-trusted non-3GPP access network;
the first security key is a master session key (MSK) or a non-seamless wireless LAN offload (NSWO) key; and
the first authentication message is an EAP Response/Identity message and the authentication response is an EAP-Success message.

86. The method of claim 84, wherein sending the authentication request is based on determining that the UE should be authenticated for accessing the first access network and for registration with the communications network.

87. The method of claim 86, wherein determining that the UE should be authenticated for accessing the first access network and for registration with the communications network is based on one of the following:
an indication that the UE is requesting authentication for accessing the first access network and for registration with the communications network, wherein the indication is included in the first authentication message; or
local policy of the first NNF that each UE authentication should be for accessing the first access network and for registration with the communications network.

88. The method of claim 84, further comprising sending to the UE via the first access network a second authentication message that includes an indication that the communications network is authenticating the UE for accessing the first access network and for registration with the communications network.

89. The method of claim 88, wherein the second authentication message is an EAP-Request message.

90. The method of claim 88, wherein one of the following applies:
sending the second authentication message is responsive to determining, based on local policy, that the UE should be authenticated for accessing the first access network and for registration with the communications network; or
the method further comprising receiving the second authentication message from the second NNF, wherein the received second authentication message is forwarded to the UE via the first access network.

91. The method of claim 84, wherein at least one of the following applies:
the indication that the UE should be authenticated for accessing the first access network and for registration with the communications network is implicit from the authentication request sent to the second NNF; and
the identifier associated with user credentials for the communications network is a subscription concealed identifier (SUCI).

92. The method of claim 84, wherein:
the communications network is a fifth-generation (5G) network;
the first NNF is a non-seamless wireless LAN offload function (NSWOF); and
the second NNF is one of the following: an access and mobility management function (AMF) separate from the NSWOF, an AMF combined with the NSWOF, or an authentication support function (AUSF).

93. The method of claim 92, wherein the authentication request also includes an address of an AMF that supports registration of the UE with the communications network.

94. A user equipment (UE) configured to communicate with a communications network via at least a first access network, the UE comprising:
communication interface circuitry configured to communicate via the first access network; and
processing circuitry operably coupled to the communication interface circuitry, wherein the processing circuitry and the communication interface circuitry are configured to:
without registering with the communications network, receive from the communications network an authentication-related message;
generate the following based on the authentication-related message:
a first security key usable for establishing a secure connection with the first access network, and
one or more second security keys usable for communicating with the communications network;
establish a secure connection with the first access network based on the first security key; and
register with the communications network based on at least one of the second security keys.

95. Network equipment configured to implement a first network node or function (NNF) of a communications network, the network equipment comprising:
communication interface circuitry configured to communicate with user equipment (UEs) and with other NNFs of the communications network; and
processing circuitry operably coupled to the the communication interface circuitry, wherein the processing circuitry and the communication interface circuitry are configured to:
receive, from a UE via a first access network, a first authentication message that includes an identifier associated with user credentials for the communications network;
send, to a second NNF of the communications network, an authentication request that includes the identifier and an indication that the UE should be authenticated for accessing the first access network and for registration with the communications network;
receive the following from the second NNF:
an authentication response indicating that the UE is authenticated according to the indication, and
a first security key usable for establishing a secure connection between the UE and the first access network; and
forward the first security key to the first access network and the authentication response to the UE via the first access network.
